(19) United States
(12) Patent Application Publication
(10) Pub. No.: US 2025/0380837 A1
(43) Pub. Date: Dec. 18, 2025

(54) FOOD WARMING DEVICE

(71) Applicant: Milwaukee Electric Tool Corporation, Brookfield, WI (US)

(72) Inventors: Aaron M. Lettner, Brookfield, WI (US); Zichen Tan, Oak Creek, WI (US); Jacob D. Hadfield, Brookfield, WI (US); Christopher R. Millane, Brookfield, WI (US); Roque M. Corpuz, JR., Brookfield, WI (US)

(21) Appl. No.: 19/233,480

(22) Filed: Jun. 10, 2025

Related U.S. Application Data
(60) Provisional application No. 63/660,837, filed on Jun. 17, 2024.
(60) Provisional application No. 63/696,296, filed on Sep. 18, 2024.
(60) Provisional application No. 63/782,355, filed on Apr. 2, 2025.

(51) Int. Cl. A47J 39/02; A47J 41/00; H05B 1/02

(52) U.S. Cl. CPC A47J 39/02; A47J 41/005; A47J 41/0094; H05B 1/0225; H05B 1/0261

(57) ABSTRACT

Quite often it is heard that people complain about having cold food at their places of work. The problem is not localized to a particular geographic area or age, it affects everyone who prefers having hot food at workplace or college. The Smart Lunch box aims at providing hot food to users anytime and anywhere they want. It uses heating elements along with microcontrollers powered by batteries to provide heat even in the absence of a power outlet. The batteries have to be sufficiently charged well before hand, the box can be controlled to set temperatures and timer through a mobile application which simplifies the user interface and also reduces human intervention. The box can also be used as a noodle maker by using hot water. The technical applications are immense. This invention can be of great help to various working sects of the society.

### CROSS-REFERENCE TO RELATED APPLICATIONS

This application claims from the benefit of U.S. Provisional Application No. 63/660,837, filed Jun. 17, 2024, U.S. Provisional Application No. 63/696,296, filed Sep. 18, 2024, and U.S. Provisional Application No. 63/782,355, filed Apr. 2, 2025, each of which is incorporated herein by reference in its entirety.

### BACKGROUND

The pace of life is often fast and hectic, leaving individuals with limited time for meal preparation and consumption. This is particularly true for individuals working in fields that require them to be on-site or on-the-go, such as construction workers, service technicians, and outdoor enthusiasts. These individuals often rely on packed meals, which can be difficult to keep warm until mealtime.

Traditional methods of warming food, such as microwaves or stovetops, are not readily available in many work or outdoor environments. Even when available, these methods can be time-consuming and inconvenient, particularly in settings where multiple individuals are attempting to warm their meals at the same time. This can lead to long wait times and rushed meals, detracting from the enjoyment of breaks and mealtimes.

### SUMMARY

Some embodiments of the present disclosure provide a food carrying device for warming food. The food carrying device can include a housing including a storage compartment defining a base and a plurality of sidewalls. The storage compartment can define a storage volume for receiving a food container or food item. The storage volume can extend between the base of the storage compartment and an open end of the storage compartment opposite the base. A lid can be secured to the housing to close the open end of the storage compartment. A heating element can extend along the storage compartment. A battery can be configured to power the heating element. A user interface can be disposed on an exterior surface of the housing. A controller can be connected to the heating element and the user interface. The controller can be configured to receive inputs from a user via the user interface. The controller can receive as a first input a desired mealtime, and in response to the first input the controller can control the heating element to output heat at a first heating level for a first period of time and output heat at a second heating level for a second period of time.

Some embodiments of the present disclosure provide a food carrying device for warming food. The food carrying device can include a housing including a storage compartment. The storage compartment can define a storage volume for receiving a food container or food item. A lid can be secured to the housing. A heating element can heat the storage compartment. A battery can power the heating element. A user interface can receive inputs from a user. A controller can be connected to the heating element and the user interface. The controller can receive a first input to the user interface corresponding to a heating parameter, and in response to the first input the controller can calculate a heating profile for the heating element. The heating profile can include a first activation level of the heating element and a first period of activation of the heating element, and a second activation level of the heating element and a second period of activation of the heating element.

Embodiments of the present disclosure include a method for using a food carrying device, the food carrying device including a storage compartment to receive a food container or food item. The method can include coupling a battery to a housing of the food carrying device. The method can include powering a heating element using the battery. The method can include receiving a first user input to a controller via a user interface where the first user input can specify a desired mealtime. Based on the desired mealtime, the method can include activating the heating element via the controller to output heat at a first heating level for a first period of time and activating the heating element via the controller to output heat at a second heating level for a second period of time.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates an isometric view of a food carrying device including a handle in a first horizontal configuration, according to aspects of the present disclosure.

FIG. 2 illustrates an isometric view of the food carrying device of FIG. 1, including the handle of the food carrying device in a second vertical configuration.

FIG. 3 illustrates an isometric view of the food carrying device of FIG. 1, including a second compartment of the food carrying device being removed.

FIG. 4 illustrates an isometric view of the food carrying device of FIG. 1, including a lid of a first storage compartment in an open configuration.

FIG. 5 illustrates an isometric view of a food carrying device, according to aspects of the present disclosure.

FIG. 6 illustrates a schematic view of an example food carrying device, according to an embodiment.

FIG. 7 illustrates an exploded view of another embodiment of a food carrying device.

FIG. 8 illustrates a cross-sectional exploded view of the food carrying device of FIG. 7.

FIG. 9 illustrates an isometric view of the food carrying device of FIG. 7.

FIG. 10 illustrates another isometric view of the food carrying device of FIG. 7 with a removable lid.

FIG. 11 illustrates an isometric view of a tray with a heating element for use with the food carrying device of FIG. 7.

FIG. 12 illustrates a schematic view of an electronics panel for the food carrying device of FIG. 7.

FIG. 13 illustrates a side view of an example of a battery recess suitable for use with the food carrying device of FIG. 7.

FIG. 14 illustrates an isometric view of another example of a battery recess suitable for use with the food carrying device of FIG. 7.

FIG. 15 illustrates an isometric view of another example of a food carrying device in a closed configuration, including a battery coupled to a housing of the food carrying device.

FIG. 16 illustrates an isometric view of the food carrying device of FIG. 15 in the closed configuration, with no battery coupled to the housing.

FIG. 17 illustrates a bottom axonometric view of the food carrying device of FIG. 15.

FIG. 18 illustrates a front view of the food carrying device of FIG. 15.

FIG. 19 illustrates an isometric view of the food carrying device of FIG. 15 in an open configuration.

FIG. 20 illustrates a cross-sectional view of the food carrying device of FIG. 15, taken at line XX of FIG. 18.

FIG. 21 illustrates another cross-sectional view of the food carrying device of FIG. 15, taken at line XXI of FIG. 18.

FIG. 22 illustrates a side view of the food carrying device of FIG. 15 in the closed configuration.

FIG. 23 illustrates an enlarged cross-sectional view of a hinge of the food carrying device of FIG. 22.

FIG. 24 illustrates a side view of the food carrying device of FIG. 15 in the open configuration.

FIG. 25 illustrates an enlarged cross-sectional view of the hinge of the food carrying device of FIG. 24.

FIG. 26 illustrates a side plan view of the food carrying device of FIG. 15 in a detached configuration.

FIG. 27 illustrates an enlarged cross-sectional view of the hinge of the food carrying device of FIG. 26.

FIG. 28 illustrates an axonometric view of the food carrying device of FIG. 15, without a lid of the food carrying device attached to the housing.

FIG. 29 illustrates a partially exploded view of the food carrying device of FIG. 15, without a lid attached to the housing.

FIG. 30 illustrates an isometric view of a food container of the food carrying device of FIG. 15, mounted on the lid.

FIG. 31 illustrates an example schematic diagram of the food carrying device of FIG. 15.

FIG. 32 illustrates an isometric view of a food carrying device, according to aspects of the present disclosure.

FIG. 33 illustrates a rear axonometric view of the food carrying device of FIG. 32.

FIG. 34 illustrates an axonometric view of the food carrying device of FIG. 32, with a lid of the food carrying device in an open configuration.

FIG. 35 illustrates a partially exploded view of the food carrying device of FIG. 32, without a lid attached to the housing.

FIG. 36 illustrates a flowchart of a method of operation of a food carrying device, according to aspects of the present disclosure.

FIG. 37 illustrates a flowchart of a method of operation of a food carrying device, according to aspects of the present disclosure.

FIG. 38 illustrates a flowchart of a method of operation of a food carrying device, according to aspects of the present disclosure.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

The following description sets forth exemplary aspects of the present disclosure. It should be recognized, however, that such description is not intended as a limitation on the scope of the present disclosure. Rather, the description also encompasses combinations and modifications to those exemplary aspects described herein.

As noted above, many people who work or travel in environments that do not have convenient access to grid power (e.g., via power outlets), are unable to enjoy hot meals. Often, these people must resort to heating their food at the beginning of the day, or before a shift, and storing the food in an insulated container. However, insulated containers have a propensity for allowing heat to escape, resulting in lukewarm or cold food at mealtimes.

Correspondingly, embodiments of the invention can provide a portable food carrying device designed to facilitate the heating and transportation of food arranged in a food container. Examples of the present invention can accordingly allow people to heat food, even when they have little to no access to grid power, microwaves, ovens, grills, or other cooking devices. The present invention can therefore allow users to have an enjoyable mealtime experience regardless of their location or the amenities at hand, ultimately providing a solution to the unmet requirements of portability and time efficiency, by allowing users to warm their lunch at their workplace, regardless of the workplace environment.

In some embodiments, the portable food carrying device comprises a housing including a heating element that is configured to heat a food container stored within the housing. The housing can include a base, which serves as the foundation of the device, and one or more storage compartments. A first storage compartment can be used for storing the food container, while a second storage compartment can be utilized for housing various components of the device, such as a heating element and a battery. As described further below, in other embodiments, the battery can be coupled to an exterior of the first storage compartment, and the food carrying device can not include a second storage compartment. As also described below, the heating element can be arranged in multiple configurations within or along the housing of the food carrying device.

A lid can be attached to the housing via a hinge. The lid can be configured to cover or close the first storage compartment to protect and maintain the temperature of the food within the compartment. As described further below, the lid can be removable from the housing, and usable as a tray for a food container of the food carrying device, to limit contact between the user and the potentially warm or hot food container.

The carrying device can include a controller configured to regulate a voltage applied to the heating element, and therefore a temperature of the heating element. The controller can be in communication with a user interface that receives inputs from the user. The user can input commands to the user interface to cause the controller to set the heating element at a desired temperature for a desired period of time, thereby providing a personalized food warming experience.

In some aspects, the device can be powered by a battery, which can be swapped out as per the user's convenience. The device can also be compatible with AC power and USB-C charging, providing multiple power options to the user.

In some embodiments, the device can include feet for stability and a tray handle for easy removal and insertion of the food tray. The device can also be compatible with Milwaukee Tool® PACKOUT™ systems, enhancing its portability and convenience for users. A handle, which can be attached to the base or the lid via a hinge, is provided for carrying the device.

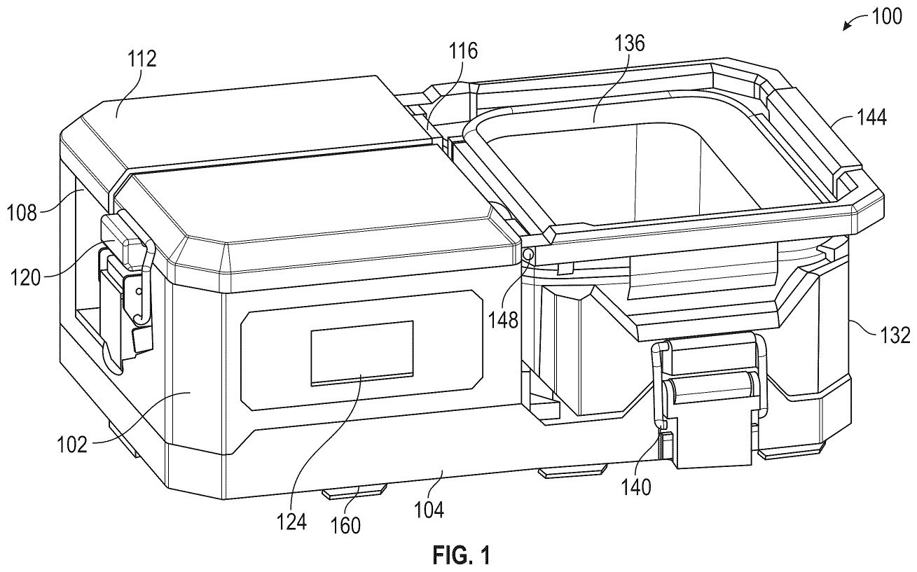

Referring to FIG. 1, the food carrying device 100 can include a housing 102. Additionally, the housing 102 can include a base 104. The base 104 can serve as the foundation of the food carrying device 100 that supports the food carrying device 100 relative to a support surface (e.g., a table, a cooler, or other support surface), providing stability and support. In some aspects, the housing 102 and the base 104 can be made of a durable material such as plastic, metal, or a composite material. The base 104 can be designed to withstand the weight of the components of the food carrying device 100 and food stored therewithin.

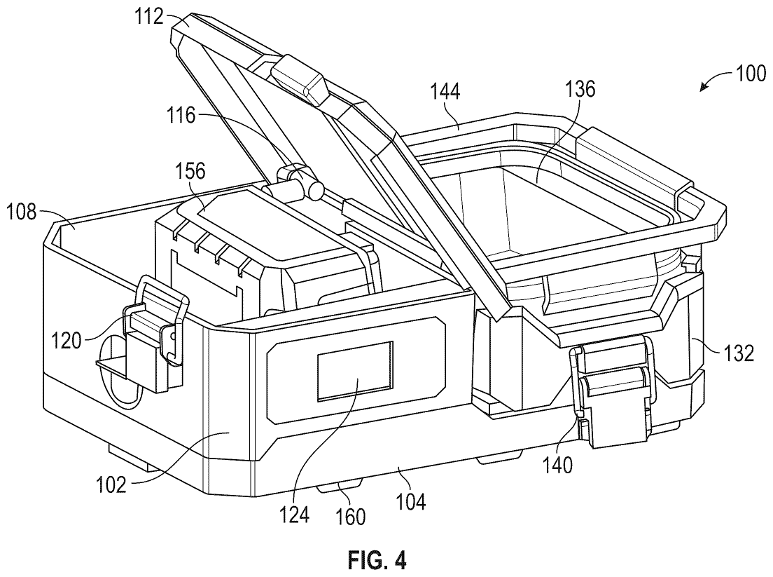

Extending from the base 104, the food carrying device 100 can include a first storage compartment 108. The first storage compartment 108 can retain a battery 156 (shown in FIG. 4). In some cases, the first storage compartment 108 can be designed to securely hold the battery 156, preventing it from moving or shifting during transport. The first storage compartment 108 can be of a size and shape to accommodate different types of batteries, including but not limited to, power tool batteries, rechargeable batteries, or custom-designed batteries for the food carrying device 100.

The food carrying device 100 can also include a lid 112. The lid 112 can be rotatable about a hinge, referred to as the lid hinge 116, to close the first storage compartment 108. In some aspects, the lid 112 can provide a seal to the first storage compartment 108, protecting the battery 156 from external elements such as dust, water, or impact. The lid 112 can be made of a durable material and can include a handle or grip for easy opening and closing. The lid 112 can be secured in a closed configuration by a fastening mechanism 120 that can be a latch or other known fastening mechanism.

The first storage compartment 108 extending from the base 104 can be waterproof or splash-proof to protect the battery 156 stored inside. This can prevent damage to the battery 156 due to exposure to water or other liquids, thereby enhancing the durability and reliability of the food carrying device 100. In some aspects, the first storage compartment 108 can include a seal or gasket to provide the waterproof or splash-proof feature. The seal or gasket can be made of a water-resistant material such as rubber or silicone.

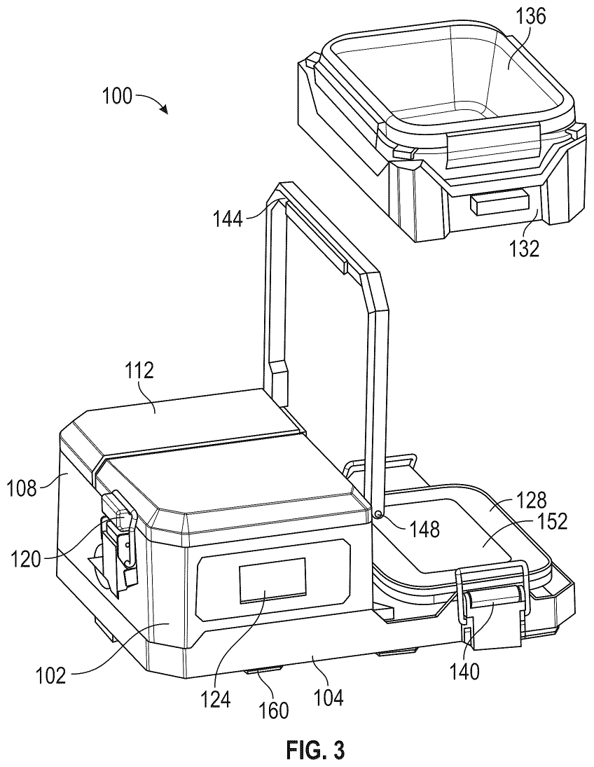

A user interface 124 can be disposed on a sidewall or the lid 112 of the first storage compartment 108, the base 104, or any other location on the food carrying device 100. The user interface 124 can allow a user to control various functions of the food carrying device 100, such as setting a desired temperature for a warming platform 128 (shown in FIG. 3) or setting a food ready time. In some cases, the user interface 124 can also display information such as battery level, current temperature, or time remaining until the food is ready. In some aspects, the user interface 124 can include a digital display and one or more buttons, which can be mechanical or touch-sensitive. The user can interact with these buttons to input the desired food ready time. The digital display can provide visual feedback to the user, such as displaying the current food heating setting, status, battery level, current temperature, time remaining, etc. In some cases, the user interface 124 can also include an audible or tactile feedback mechanism, such as a beep or vibration, to confirm the user's input. The user interface 124 can be designed for easy operation and can include visual indicators such as LED lights or a digital display to provide feedback to the user.

As shown in FIG. 3, the food carrying device 100 can further include a warming platform 128 extending from the base 104. The warming platform 128 can house a heating element 152. For example, the heating element 152 can be embedded within the warming platform 128 or can be attached to the underside of the warming platform 128. In some embodiments, the heating element 152 can be ceramic, metallic, carbon (e.g., carbon nanotube), or any other suitable material. The output of heat from the heating element 152 can be controllable by a user interacting with the user interface 124. For example, the user can set a desired temperature for the heating element 152 via the user interface 124, and the heating element 152 can adjust its output of heat accordingly. In some aspects, the warming platform 128 can be designed to evenly distribute the heat from the heating element 152, ensuring consistent warming of the food. The warming platform 128 can be made of a heat-resistant material and can include a non-stick surface for easy cleaning.

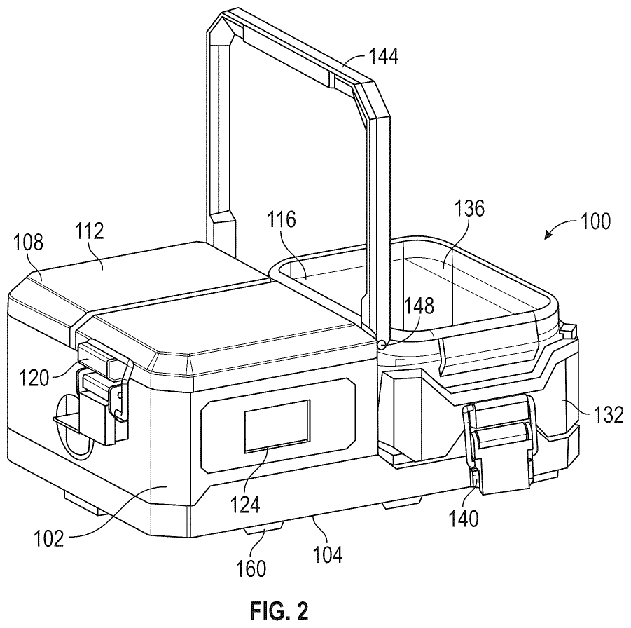

Continuing with the description of FIG. 1, as well as FIGS. 2-4, the food carrying device 100 can also include a second storage compartment 132. The second storage compartment 132 can be removably coupled to the base 104, as shown in FIG. 3, and can be configured to retain a container 136 of food. In some aspects, the second storage compartment 132 can be designed to fit onto the warming platform 128, allowing food within the container 136 to be warmed by the heating element 152. In some aspects, the second storage compartment 132 and the container 136 can be made of a heat-resistant material, such as metal, ceramic, or heat resistant plastic, to withstand the heat from the warming platform 128. The second storage compartment 132 and the container 136 can also include a lid or cover (not shown) to maintain the temperature of the food within the container 136. In some cases, the lid or cover can be removable or hinged, allowing easy access to the food within the container 136.

The food carrying device 100 can further include a handle 144. The handle 144 can be rotatable about a hinge, referred to as the handle hinge 148, between a vertical transport configuration (shown in FIGS. 2 and 3) and a horizontal locked configuration (shown in FIGS. 1 and 4). In the horizontal locked configuration (e.g. a first configuration), the handle 144 can help secure the container 136 within the second storage compartment 132. This can prevent the container 136 from moving or shifting during transport, thereby ensuring the safety of the food within the container 136. In some aspects, the handle 144 can be designed to provide a comfortable grip, and can be made of a durable material to withstand the weight of the food carrying device 100.

Additionally, as shown in FIGS. 1-4, the base 104 of the food carrying device 100 can include feet 160. The feet 160 can be made of a high-friction material, such as rubber or silicone, configured to ensure that the food carrying device 100 does not accidentally slide across a surface. In some cases, the feet 160 can be designed to provide stability to the food carrying device 100, especially when the device 100 is placed on a sloped or uneven surface. In some aspects, the feet 160 can be detachable or adjustable, allowing the user to customize the stability and positioning of the food carrying device 100 as per their requirements. In some cases, the feet 160 can engage receiving recesses in a larger assembly, allowing the food carrying device 100 to be secured within the larger assembly. This can provide additional stability to the food carrying device 100, especially when the device 100 is used in a moving vehicle or on a sloped surface.

In some aspects, the food carrying device 100 can be compatible with modular storage systems, such as a Milwaukee Tool® PACKOUT™ System. Modular storage systems are modular storage systems that allow various tools and devices to be securely stored and transported in a compact and organized manner. The food carrying device 100 can include one or more attachment mechanisms, such as hooks, clips, or latches, that can engage corresponding attachment points on a modular storage system. This can allow the food carrying device 100 to be securely attached to the modular storage system, facilitating easy and convenient transport of the food carrying device 100 along with other tools and devices. In some cases, the food carrying device 100 can be designed to fit within a specific compartment or slot of the modular storage system, further enhancing the compactness and organization of the system.

As noted above and referring to FIGS. 2 and 3, the handle 144 of the food carrying device 100 can be placed in a second, vertical configuration (e.g., a vertical transport configuration). In this configuration, the handle 144 can be oriented vertically, extending upwards from the base 104. In the vertical configuration, the handle 144 may not secure the second storage compartment 132 and the container 136 to the base 104. This can allow the second storage compartment 132 and the container 136 to be removed from the base 104, for example, for cleaning, refilling, or replacement. In some aspects, the handle 144 can include a locking mechanism, such as a latch or a clip, to secure the second storage compartment 132 and the container 136 to the base 104 when the handle 144 is in the horizontal locked configuration. However, in the vertical configuration, this locking mechanism can be disengaged, allowing the second storage compartment 132 and the container 136 to be freely removed from the base 104.

In some embodiments, the second storage compartment 132 and the container 136 can be designed for easy removal and insertion onto the warming platform 128. For instance, the second storage compartment 132 and the container 136 can include handles or grips, which a user can grasp to lift and remove the second storage compartment 132 and the container 136 from the warming platform 128. In some cases, the second storage compartment 132 and the container 136 can include a locking mechanism 140, such as a latch or a clip, to secure the second storage compartment 132 and the container 136 to the warming platform 128. However, this locking mechanism 140 can be disengaged to allow the second storage compartment 132 and the container 136 to be freely removed from the warming platform 128, as shown in FIG. 3.

Referring to FIG. 4, the lid 112 is depicted in an open configuration, revealing the first storage compartment 108 and the battery 156 secured within. The battery 156 can be a power source for the food carrying device 100, providing the electrical energy to power the heating element 152 and other electrical components of the device 100. In some aspects, the battery 156 can be a rechargeable battery, allowing the user to recharge the battery 156 when it is depleted, thereby reducing the cost and waste associated with disposable batteries.

In some cases, the battery 156 can be swappable, allowing the user to replace a depleted battery 156 with a fully charged battery. This can be particularly useful in situations where the user does not have access to a power source to recharge the battery 156, such as when the user is at a remote job site or on a camping trip. The ability to swap the battery 156 can also allow the user to use the food carrying device 100 for extended periods of time, by carrying multiple fully charged batteries and swapping them out as each battery becomes depleted.

In some embodiments, the battery 156 can be a power tool battery. Power tool batteries are typically designed to provide a high amount of electrical energy in a compact form factor, making them well-suited for powering the heating element 152 and other electrical components of the food carrying device 100. Power tool batteries are also typically designed to be durable and reliable, capable of withstanding the rigors of a job site or other demanding environments. In some cases, the user can already own power tool batteries for their power tools, allowing the user to use these batteries with the food carrying device 100, thereby reducing the cost and inconvenience of purchasing separate batteries for the food carrying device 100.

The first storage compartment 108 can include a battery port (not shown) that retains the battery 156 and transfers electricity from the battery 156 to the electrical components of the food carrying device 100. The battery port can include electrical contacts that engage corresponding contacts on the battery 156, allowing electricity to flow from the battery 156 to the electrical components of the food carrying device 100. The battery port can also include a mechanical retention mechanism, such as a latch or a clip, that securely holds the battery 156 within the first storage compartment 108, preventing the battery 156 from moving or shifting during transport. In some aspects, the battery port can be shaped and sized to match the shape and size of the battery 156 that is a power tool battery.

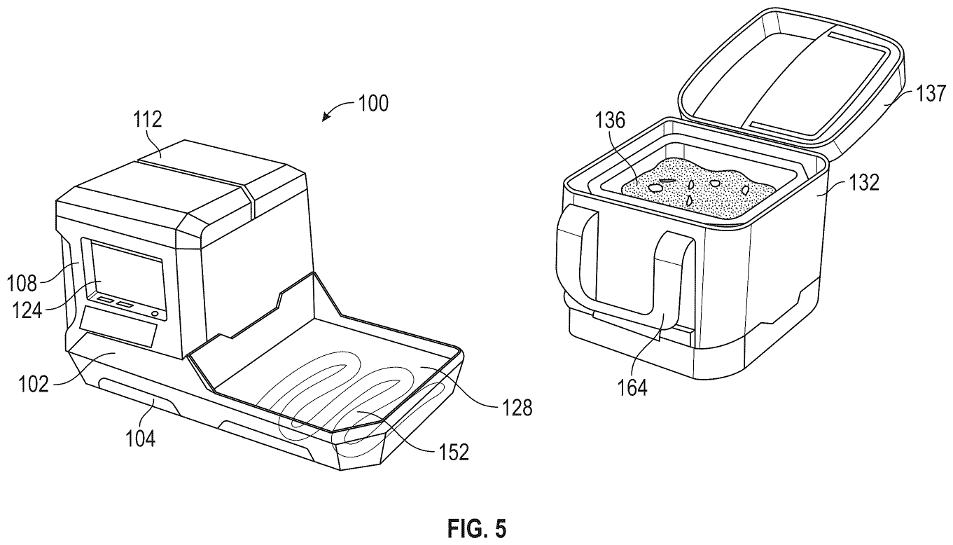

Referring now to FIG. 5, another example food carrying device 100 is illustrated. The food carrying device 100 of FIG. 5 can be substantially similar to the food carrying device 100 of FIGS. 1-4, with additional features of the second storage compartment 132 being depicted in the device 100 of FIG. 5. For example, in some aspects, the second storage compartment 132 can include handles 164 for easy removal. The handles 164 can be attached to the second storage compartment 132 and can be designed to provide a comfortable and secure grip for the user. The handles 164 can be made of a durable material, such as plastic, textile, or metal, to withstand the weight of the second storage compartment 132 and the container 136. In some cases, the handles 164 can be retractable or foldable, allowing the handles 164 to be stowed away when not in use, thereby reducing the overall size of the second storage compartment 132.

In some embodiments, the second storage compartment 132 can include a lid 137 that can be fastened by a zipper or other fastening mechanism. The fastening mechanism can be designed to securely close the lid 137, thereby helping to maintain the temperature of the food within the container 136 and protecting the food from external elements such as dust or insects. The fastening mechanism can be easy to operate, allowing the user to quickly and conveniently open and close the lid. In some cases, the fastening mechanism can include a lock, providing additional security for the food within the container 136.

In some aspects, the second storage compartment 132 can resemble a conventional lunchbox. This can provide a familiar and intuitive user experience, as many users are accustomed to using conventional lunchboxes for carrying their food. In some cases, the second storage compartment 132 can include compartments or dividers, allowing the user to organize their food in a convenient and efficient manner.

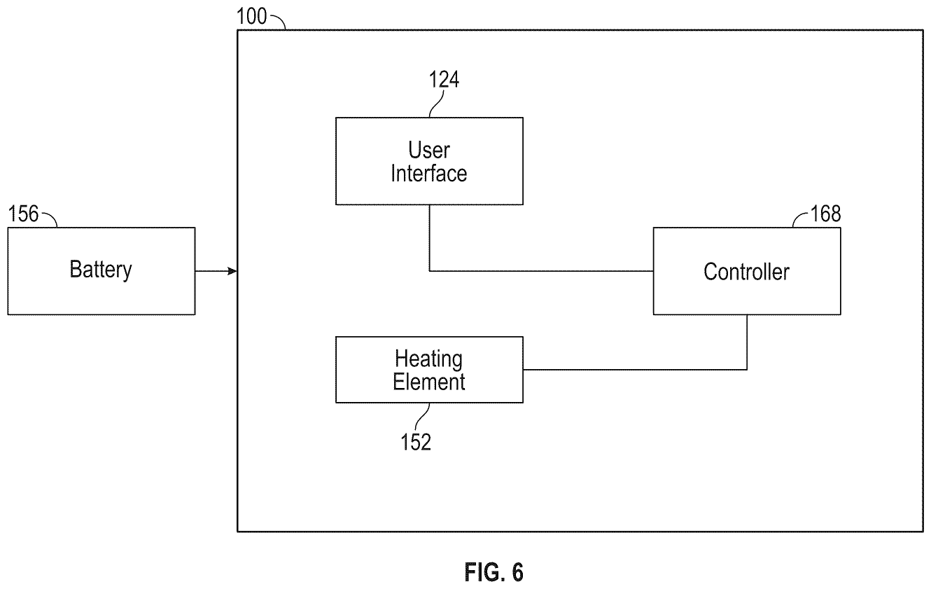

Referring to FIG. 6, an example schematic view of the food carrying device 100, powered by the battery 156, is depicted. The battery 156 can provide the electrical energy to power the heating element 152 and other electrical components of the food carrying device 100. Interacting with the user interface 124 can cause a controller 168 of the food carrying device 100 to control and increase or decrease a temperature of the heating element 152 based on the preferences of the user. As noted above, the user interface 124 can include a screen (e.g., digital display) and one or more digital or mechanical buttons. The user can interact with these buttons to input the desired temperature for the heating element 152. The digital display can provide visual feedback to the user, such as displaying the current temperature setting. In some cases, the user interface 124 can also include an audible or tactile feedback mechanism, such as a beep or vibration, to confirm the user's input.

In some aspects, the food carrying device 100 can be compatible with AC power, e.g., as an alternative to battery power. This compatibility can allow the food carrying device 100 to be powered by an AC power source, such as a wall outlet or a generator. This can be particularly useful in situations where the user has access to an AC power source and the battery 156 is depleted or not available. Accordingly, in such aspects, the food carrying device 100 can include an AC power port, which can be designed to receive an AC power plug. The AC power port can include electrical contacts that engage corresponding contacts on the AC power plug, allowing electricity to flow from the AC power source to the electrical components of the food carrying device 100.

In some cases, the food carrying device 100 can include a USB-C charging port. The USB-C charging port can allow the food carrying device 100 to be charged using a USB-C cable, which can be connected to a USB power source, such as a computer, a power bank, or a USB wall charger. This can provide a convenient and versatile charging option for the user, as USB-C cables and power sources are widely available and commonly used for charging various electronic devices. The USB-C charging port can be designed to receive a USB-C plug, and can include electrical contacts that engage corresponding contacts on the USB-C plug, allowing electricity to flow from the USB power source to the battery 156 or other electrical components of the food carrying device 100.

In some embodiments, the food carrying device 100 can be capable of operating using both AC power and battery power. This dual power capability can provide flexibility and convenience to the user, allowing the user to choose the power source that is the most suitable or available in a given situation. For example, the user can use AC power when an AC power source is available, and switch to battery power when the food carrying device 100 is being used in a location where an AC power source is not available. In some cases, the user interface 124 can allow the user to select the power source, and can display information about the current power source and power level. However, in other configurations, the food carrying device 100 can be capable of operating from a single type of power source (e.g., solely DC battery power or solely AC power).

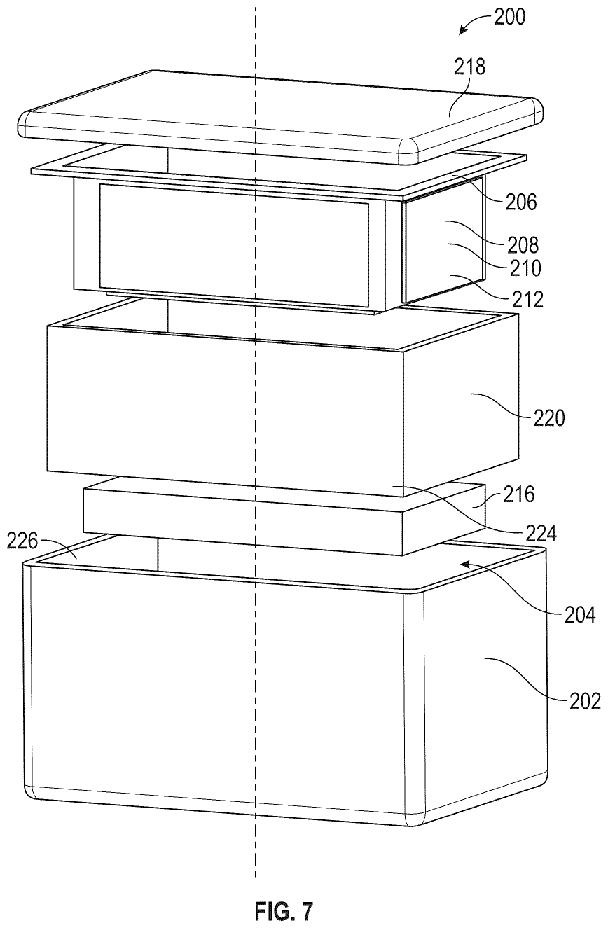

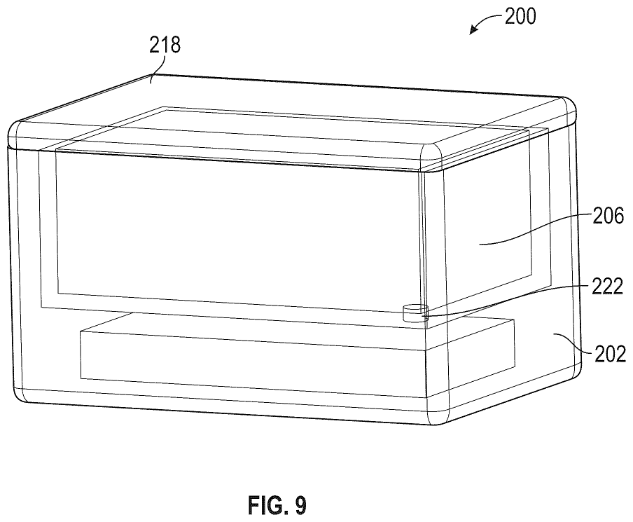

Furthermore, in other configurations, a food carrying device can instead include a singular storage compartment. In this regard, for example, FIGS. 7-14 illustrate another embodiment of a food carrying device 200. The food carrying device 200 of FIGS. 7-14 can generally include similar features as the food carrying device 100 of FIGS. 1-6. As such, unless specifically described otherwise, any such description related to the food carrying device 100 of FIGS. 1-6 may equally apply to the food carrying device 200, and vice versa.

As shown in FIGS. 7-10, the food carrying device 200 can include a shell 202, a tray 206 with one or more heating elements 208, an electronics panel 216, and a lid 218. The shell 202 can have a compartment 204 to support the food carrying device 200 relative to a support surface (e.g., a table, ground, or other support surface), providing stability and support. The shell 202 can be designed to protect the food and the internal components of the food carrying device 200. In some embodiments, the shell 202 can be of a durable material such as plastic, metal, or a composite material. In some embodiments, the shell 202 can include wheels (not shown) on the bottom for the user to roll the food carrying device 200 on a surface. In some embodiments, the shell 202 can include feet on the bottom for the food carrying device 200 to rest on a surface (e.g., as described with respect to the previous embodiment of FIGS. 1-6).

As shown in FIGS. 7-11, extending from the shell 202, the food carrying device 200 can include a tray 206 that stores food. In some embodiments, the tray 206 may be removable from the shell 202. In some embodiments, the tray 206 can be made of a durable material such as metal, where the metal is at least one of steel and aluminum.

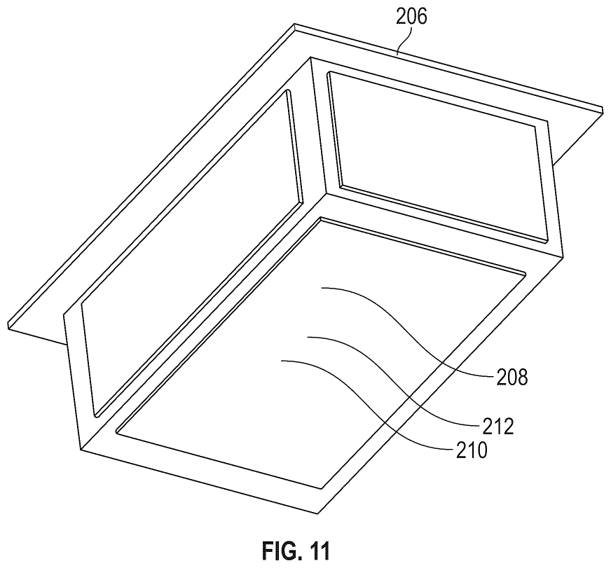

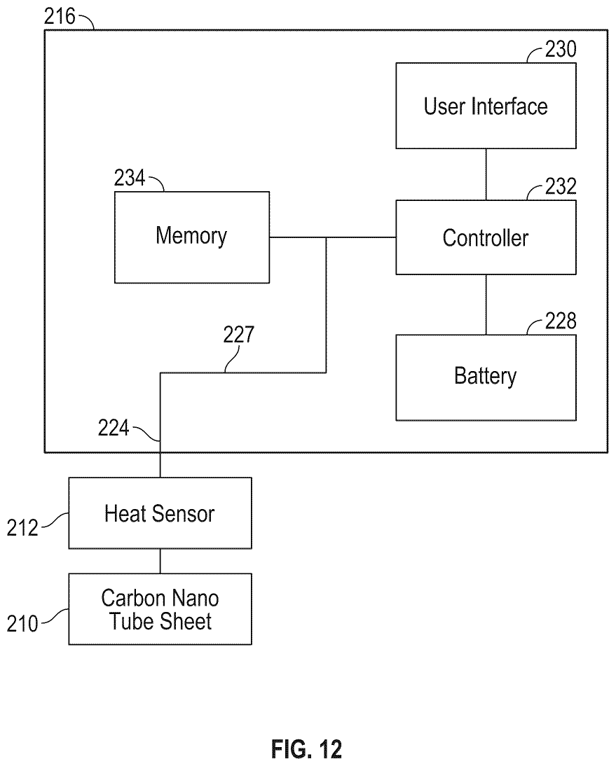

Additionally, the tray 206 can include one or more heating elements 208. In some embodiments, the heating element 208 can include a carbon nano tube sheet 210 with or without an embedded heat sensor 212. The heat sensor 212 can generate a temperature signal that can be communicated to a controller 232, as shown in FIG. 12. In some embodiments, the heat sensor 212 can include one or more of a thermistor, a thermocouple, a resistance temperature detector, or a semiconductor-based sensor. In some embodiments, the thermistor may be negative temperature coefficient thermistor or a positive temperature coefficient thermistor. Additionally, in some embodiments, the carbon nano tube sheet 210 of the heating element 208 may be replaced with a sheet or adhesive film with resistive traces in it or another suitable heat source.

As shown in FIGS. 7-10, the food carrying device 200 can also include an electronics panel 216 (e.g., including the controller 232). The electronics panel 216 can be connected to the carbon nano tube sheet 210 and the heat sensor 212. The electronics panel 216 can control the carbon nano tube sheet 210 based on the temperature signal from the heat sensor 212. In some embodiments, the carbon nano tube sheet 210 can include a hexagonal lattice of carbon atoms bent to form cylinders positioned along the surface of the sheet 210.

As noted above, the food carrying device 200 can further include a lid 218. The lid 218 can be removably coupled to the shell 202. In some embodiments, the food carrying device 200 can include a lid 218 that can be fastened by a zipper or other fastening mechanism. In other embodiments, the food carrying device 200 can include a lid 218 rotatable about a hinge (e.g., as shown in the previous embodiment of FIGS. 1-6). In yet further embodiments, the food carrying device 200 can include a lid 218 that couples to the shell 202 by a friction fit. In some embodiments, the lid 218 can include a handle (not shown) for the user to carry the food carrying device 200. In some embodiments, the shell 202 can include handles for the user to carry the food carrying device 200. In some embodiments, the handles can be retractable or foldable, allowing the handles to be stowed away when not in use. One embodiment of handles is shown and described with respect to the previous embodiment of FIGS. 1-6. Additionally, in some embodiments, the tray 206 can include its own dedicated lid (not shown), separate from the lid 218.

Additionally, as shown in FIGS. 7-10, the food carrying device 200 can include an insulation layer 220 that can be positioned between the shell 202 and the tray 206. In some examples, the food carrying device 200 can include a hole 222 in the insulation layer 220 to route a cable 224 therethrough (as shown schematically in FIG. 12).

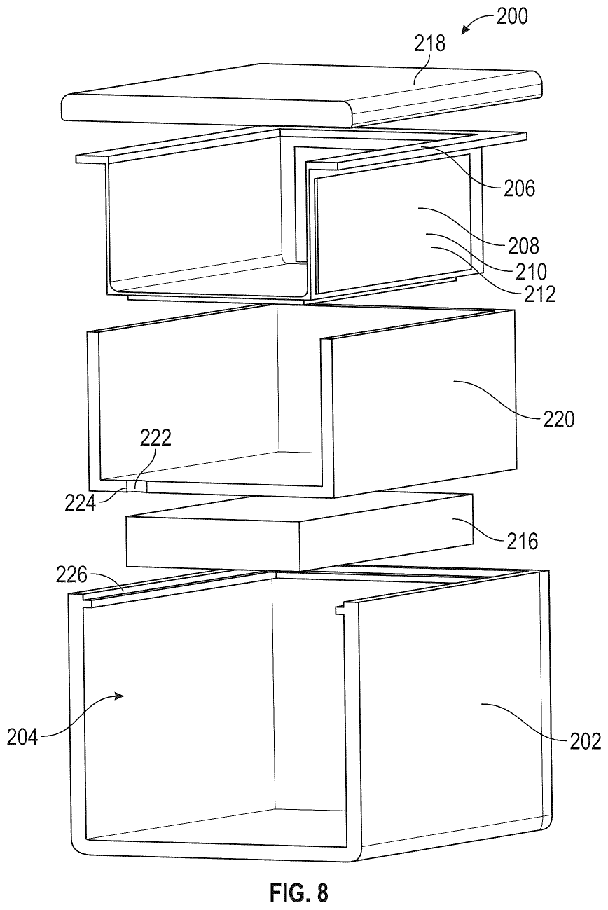

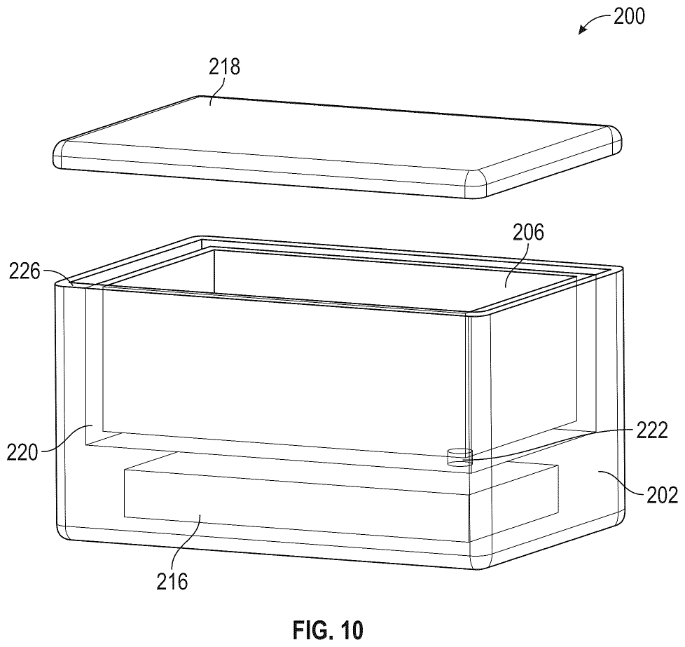

As best shown in FIGS. 8 and 10, the food carrying device 200 and, more specifically, the shell 202, can include a ledge 226 that supports the tray 206. The ledge 226 can allow the tray 206 to be surrounded by the insulation layer 220. In some embodiments, the ledge 226 can also allow the tray 206 to not directly touch the electronics panel 216.

FIG. 11 illustrates the tray 206 with the heating elements 208 when removed from the shell 202. In one embodiment, the carbon nano tube sheet 210 and the heat sensor 212 can be positioned on any number of six sides of the tray 206. In one embodiment, the carbon nano tube sheet 210 and heat sensor 212 can be positioned on five sides of the tray 206. In one embodiment, the carbon nano tube sheet 210 and the heat sensor 212 can be positioned on only the bottom surface of the tray 206. In other embodiments, the carbon nano tube sheet 210 and the heat sensor 212 can be separate from one another. In one embodiment, the carbon nano tube sheet 210 can be positioned on the sides of the tray 206 and the heat sensor 212 can be on the bottom side of the tray 206. In some embodiments, the heat sensor 212 can be a probe that is place into the food.

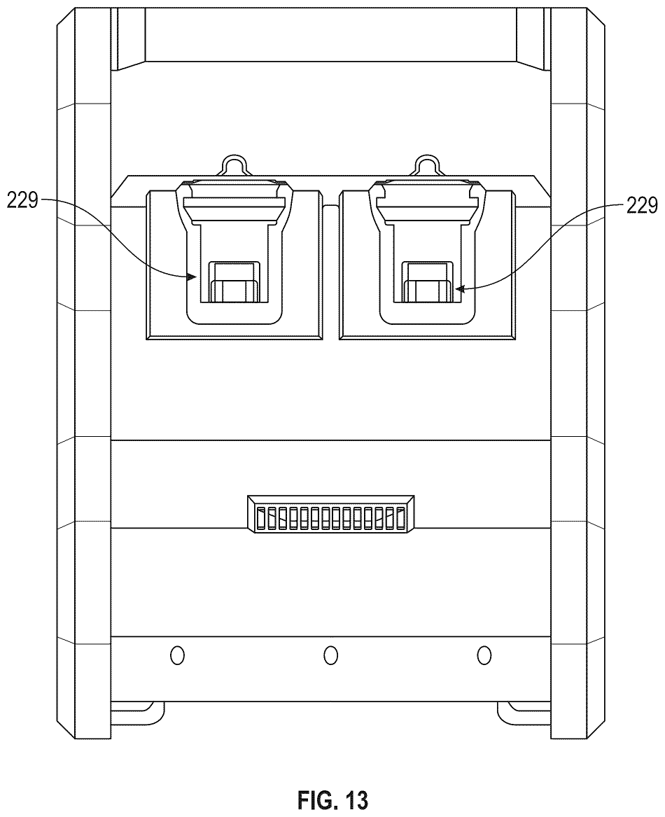

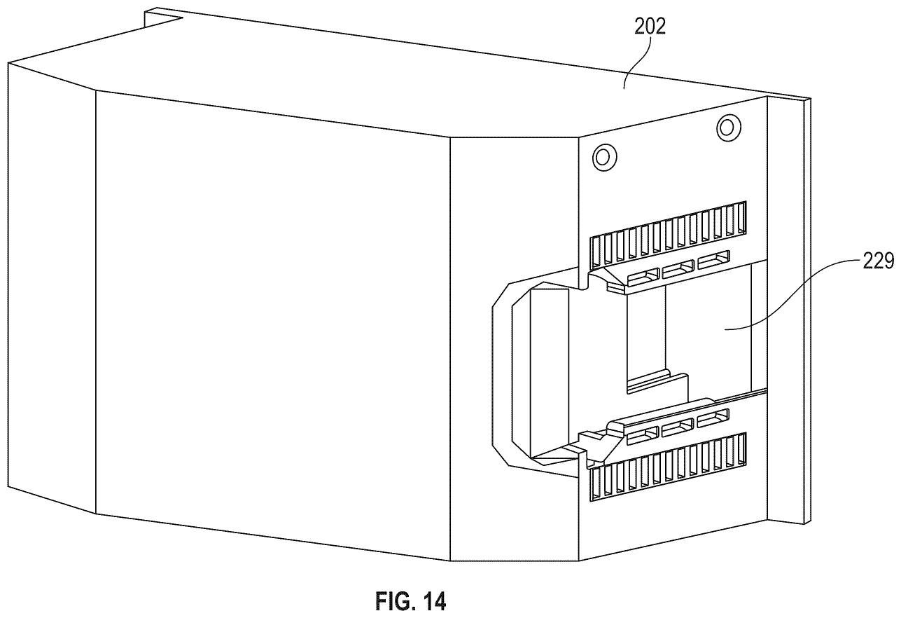

FIG. 12 schematically illustrates the electronics panel 216. The cable 224 can be connected between the electronics panel 216 and the carbon nano tube sheet 210 to provide power to the carbon nano tube sheet 210. The cable 224 can communicate a temperature signal 227 from the heat sensor 212 to the electronics panel 216. The electronics panel 216 can include a battery 228, such as a power tool battery. In some embodiments, the shell 202 can include a recess 229 (e.g., a battery port), as shown in FIG. 13 and FIG. 14, to receive the battery 228, allowing electricity to flow from the power tool battery 228 to the electronic components of the food carrying device 200.

In some embodiments, the food carrying device 200 can be designed to also receive AC power, such as from a wall outlet or generator. In other embodiments, the food carrying device 200 can be compatible for operation with AC power, e.g., when not connected to the battery 228. For example, the foot carrying device 200 can include a USB-C port (not shown) designed to receive a USB-C plug that is connected to a USC-C cable. The USB-C cable can be connected to a USB power source, such as a computer, a power bank, or a USB wall charger.

Referring back to FIG. 12, the food carrying device 200 can also include a user interface 230 (e.g., similar to the user interface described above with respect to the embodiment of FIGS. 1-6). The user interface 230 can include a screen and one or more digital or mechanical buttons. The user interface 230 can allow a user to set a desired temperature for the heating element 208. In some embodiments, the user interface 230 can allow the user to select the power source, and can display information about the current power source and power level. The user interface 230 can communicate with a controller 232. The controller 232 can communicate with the battery 228 and memory 234. For example, the controller 232 can communicate with the battery 228 to receive one or more battery characteristics such as, but not limited to, capacity, voltage, battery housing temperature, battery cell temperature, and battery impedance. In some embodiments, the memory 234 can store the user's last temperature setting.

The food carrying device 200 can be controlled by the user interface 230, e.g., via the controller 232, to allow the user to set a desired temperature for the tray 206. For example the controller 232 receives the desired temperature input by a user and sends an electrical current to the carbon nano tube sheet 210. The heat sensor 212 sends a temperature signal 227 to the controller 232 when the temperature changes. In some embodiments, the controller 232 is a PID (proportional-integral-derivative) controller. Using PID control, the PID controller reads the temperature signal 227 to determine the electrical current to be sent to the carbon nano tube sheet 210 to achieve the desired temperature.

Accordingly, to operate the food carrying device 200, the user sets a desired temperature for the food carrying device 200, the user lifts a lid 218 of the food carrying device 200, and the user places food in the tray 206. In some embodiments, the lid 218 lifts about a hinge. In other embodiments, the lid 218 lifts by unfastening a zipper or other fastening mechanism. The user using the food carrying device 200 can also turn off the food carrying device 200 (e.g., stop heating) via the user interface 230.

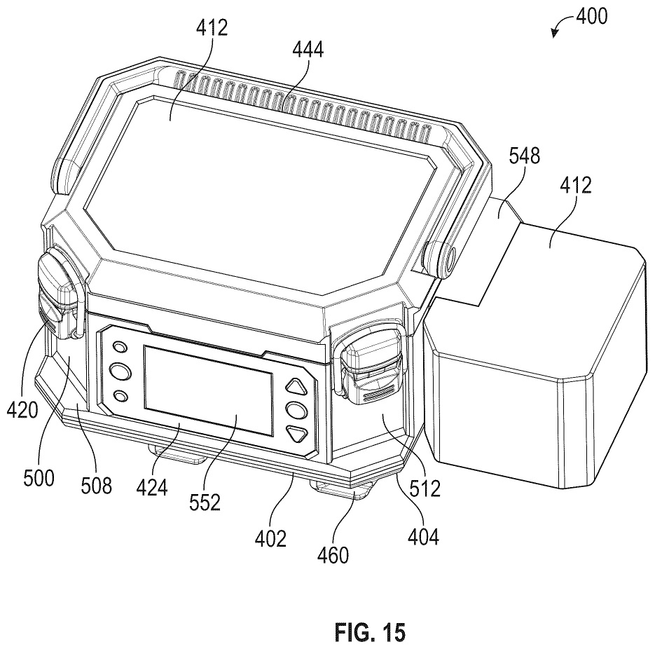

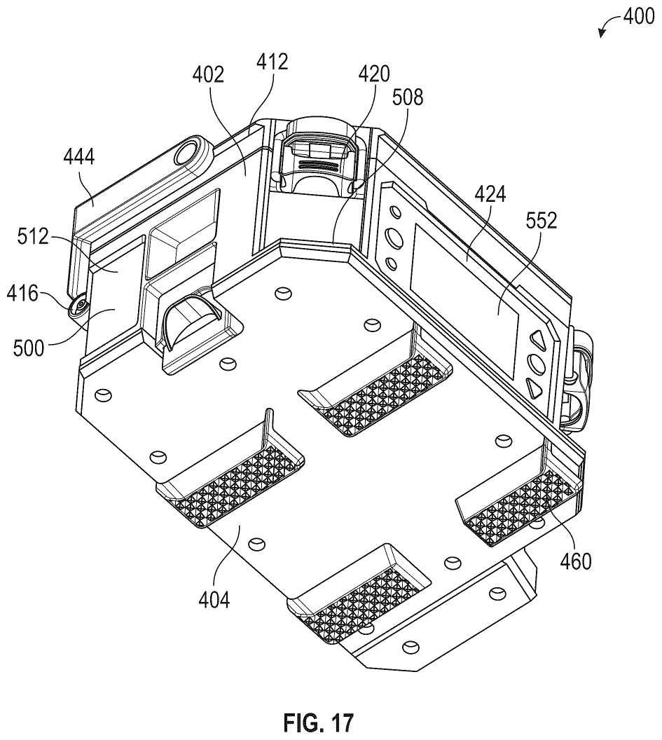

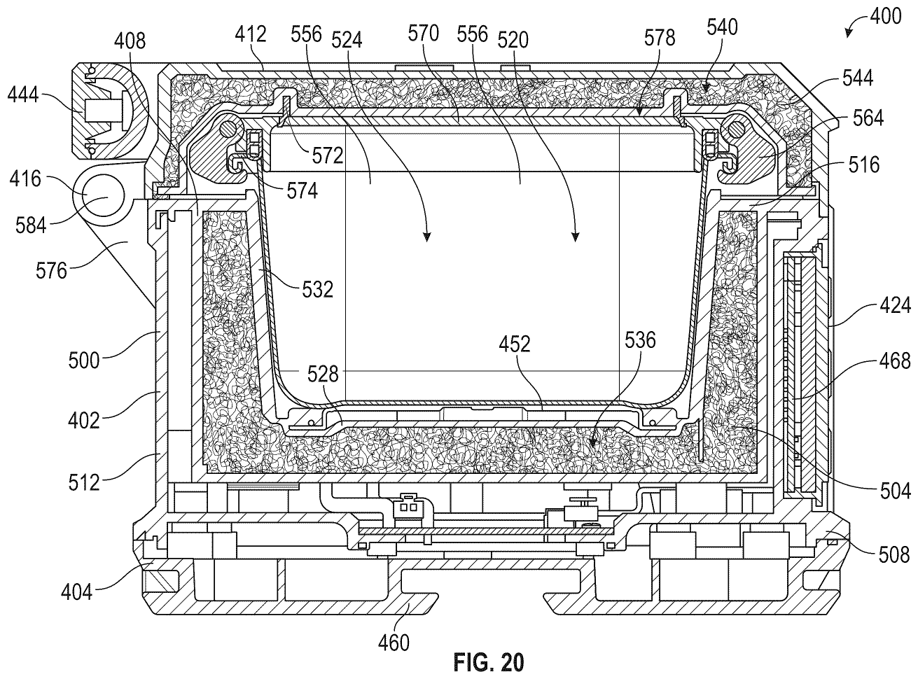

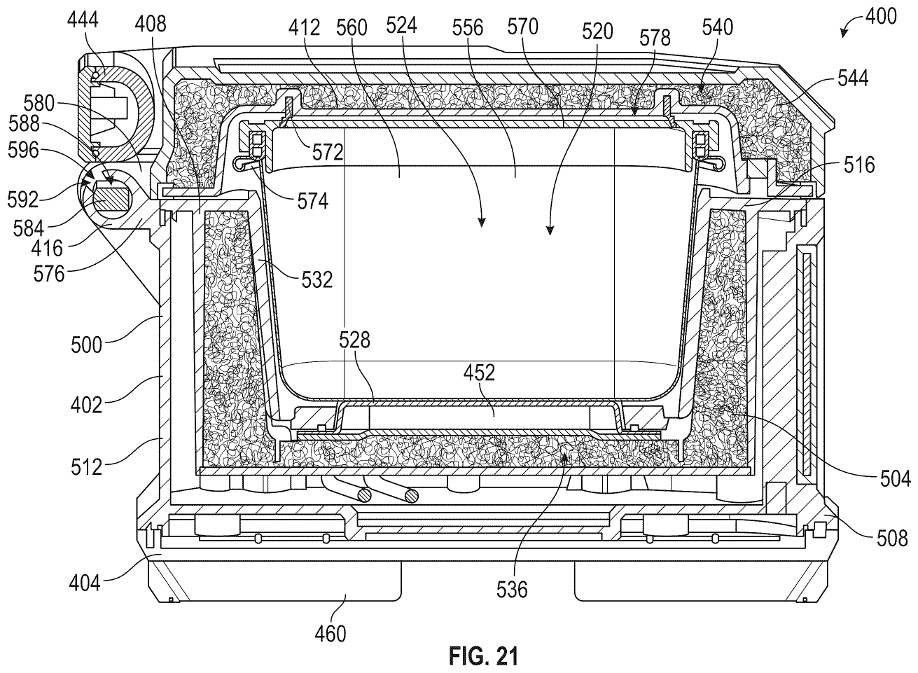

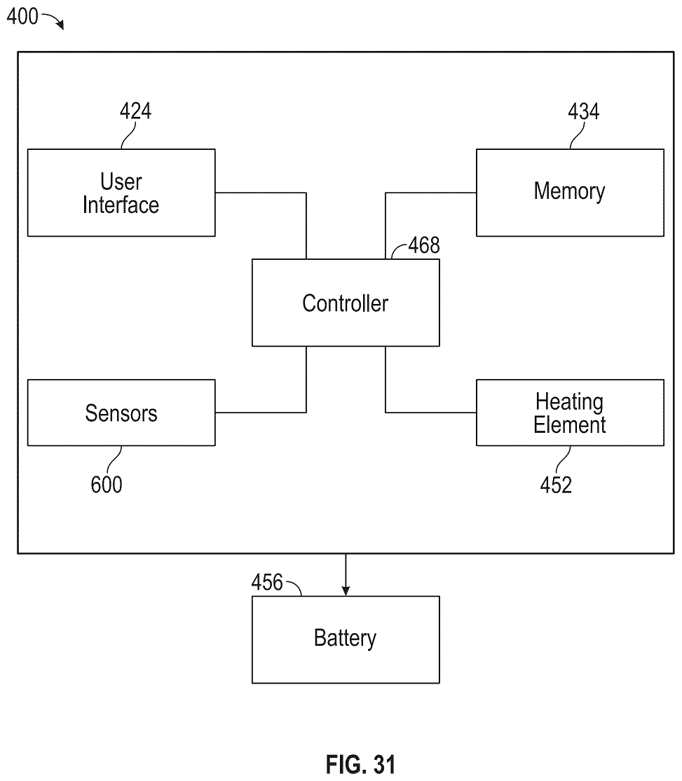

FIGS. 15-31 illustrate another embodiment of a food carrying device 400. The food carrying device 400 of FIGS. 15-30 can generally include similar features as the food carrying device 100 of FIGS. 1-6 and the food carrying device 200 of FIGS. 7-14, including but not limited to a housing 402, a base 404, a first storage compartment 408 (e.g., a tray), a lid 412, a lid hinge 416, a fastening mechanism 420, a user interface 424, a memory 434 and a controller 468 (shown in FIG. 31), a handle 444, a heating element 452, a battery 456, engaging features or feet 460, a controller 468, a shell 500, and an insulation layer 504 (shown in FIGS. 20 and 21). Thus, discussion of the food carrying devices 100, 200 above also generally applies to similar components of the food carrying device 400 (and vice versa).

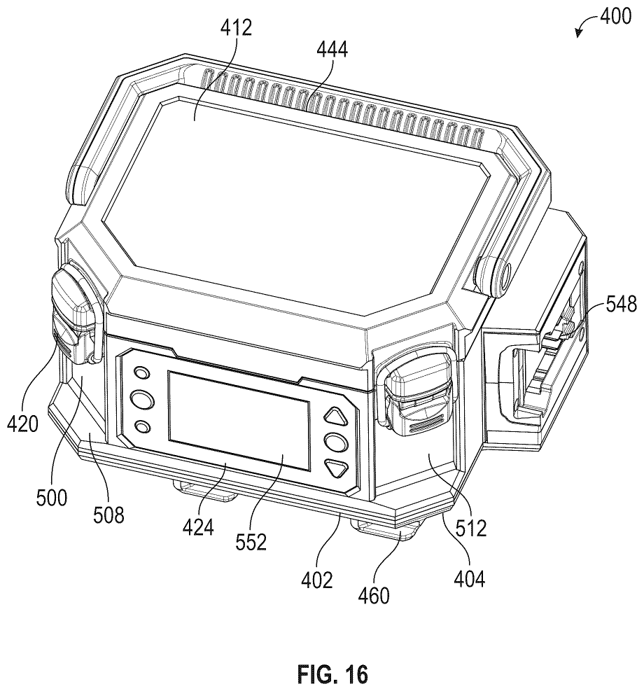

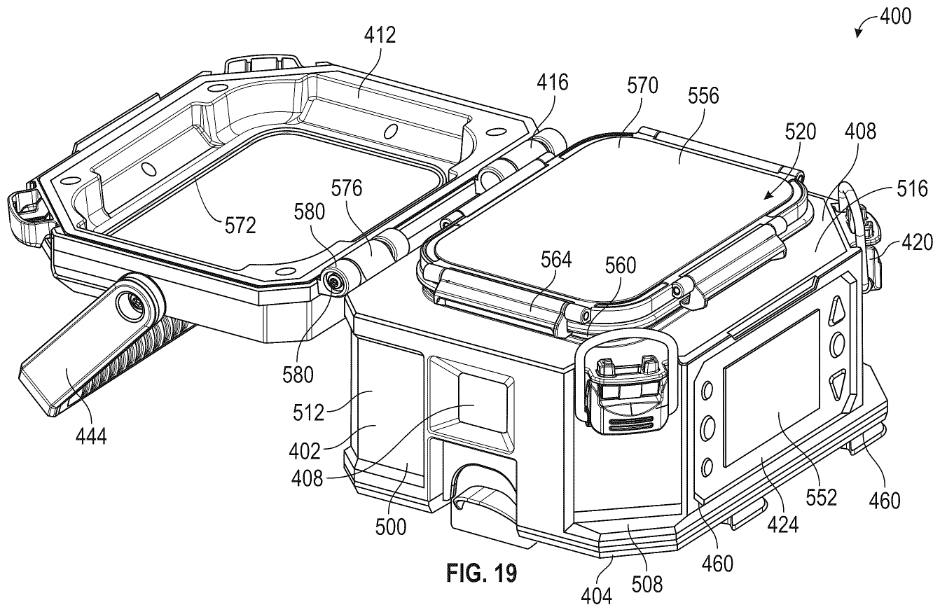

FIGS. 15 and 16 illustrate the food carrying device 400 including the housing 402. The housing 402 can include the base 404, the shell 500, and the first storage compartment 408. An open end 520 of the first storage compartment 408 (shown in FIG. 19) can be closed by the lid 412 (as shown in FIG. 20). Furthermore, the lid 412 can be secured to the housing 402 (e.g., the shell 500) by the lid hinge 416 on a first side of the housing 402. The lid 412 can be rotatable about the lid hinge 416 to selectively expose an interior volume of the first storage compartment 408. IN some examples, the lid 412 can be selectively removable from the housing 402 to allow the lid 412 to function as a tray for holding a user's food items.

In some embodiments, the lid 412 can be locked against rotation about the lid hinge 416 by one or more of the locking mechanisms 420. The locking mechanisms 420 can be disposed on a second side of the first storage compartment 408, opposite the first side. The locking mechanisms 420 can each include a hook and latch configuration that extends from the housing 402 (e.g., the shell 500) to engage a protrusion disposed on the lid 412. However, other configurations of the locking mechanisms 420 can be utilized to secure the lid 412 such as press fit mechanisms, snap-fit mechanisms, magnets, and other suitable locking mechanisms.

As described above, the lid 412 can further include a handle 444 that conveniently allows a user to pick up and carry the food carrying device 400. In the present embodiment, the handle 444 is secured to and rotatable relative to the lid 412. However, in other embodiments, the handle 444 could instead be secured to and rotatable relative to the housing 402.

In some embodiments, the lid 412 can provide a protective barrier for any food within the first storage compartment 408 and other internal components of the food carrying device 400, to ensure the food carrying device 400 is durable and resistant to drops or other such blunt force incidents. Specifically, in some embodiments, the material of the lid 412 can comprise a metal, ceramic, plastic, or other known durable material.

FIGS. 15 and 16 show that the shell 500 can include a shell base 508 that is coupled to the base 404. The shell base 508 can be coupled to the base 404 via a press fit, snap-fit, adhesive, fasteners, overmolding, etc. In other embodiments, the shell base 508 can instead be integrally formed with the base 404. The shell 500 can include a plurality of shell sidewalls 512 that extend from the base 404, or the shell base 508, to a first shell end opposite the base 404 and the shell base 508. The shell 500 can be constructed of a plastic or other applicable durable material, such as metal or ceramic, to protect the internal components of the food carrying device 400.

As shown in FIGS. 15 and 16, in some embodiments, a battery port 548 can be disposed on one of the shell sidewalls 512 between the base 404 and the first shell end. The battery port 548 can include electrical contacts that engage corresponding contacts on the battery 456 (shown attached in FIG. 15), allowing electricity to flow from the battery 456 to the electrical components of the food carrying device 400. The battery port 548 can also include a mechanical retention mechanism, such as a latch or a clip, that securely holds the battery 456 (as shown in FIG. 15). In some embodiments, the battery port 548 can include a gasket or seal, to restrict incursion of water and particulate to the battery port 548 while the battery 456 is coupled to the battery port 548. As described above, in some cases, the battery 456 can be selectively removable from the battery port 548 to allow the user to swap the battery 456 for a battery having more charge.

In some examples, the food carrying device 400 can be coupled to or otherwise integrated with a modular storage and transport assembly to allow the food carrying device 400 to be easily transported along with other equipment. FIGS. 15-17 (along with FIGS. 20 and 21 described further below) illustrate that the base 404 can include a plurality of engaging features 460 that can stabilize the base 404. The engaging features 460 may be cleats that can be received in recesses positioned on a tool case, a storage container, or another storage component. Referring specifically to FIG. 20, in other examples, the profile of the engaging features 460 can form channels to receive protrusions on the tool case, storage container, or other storage component. As such, the protrusions of the modular storage system can be received and secured by the channels of the engaging features 460, to secure the food carrying device 400 to the tool case, storage container, or other storage component, allowing the food carrying device 400 to be conveniently transported with tools or other necessary equipment. In some examples, the engaging features 460 may include male or female connectors or fasteners that are selectively engageable with corresponding male or female connectors or fasteners disposed on the on the tool case, storage container, or other storage component. One example of such a system is the PACKOUT™ System by Milwaukee Tool®. In other embodiments, the engaging features 460 may be formed differently to interface with a different system.

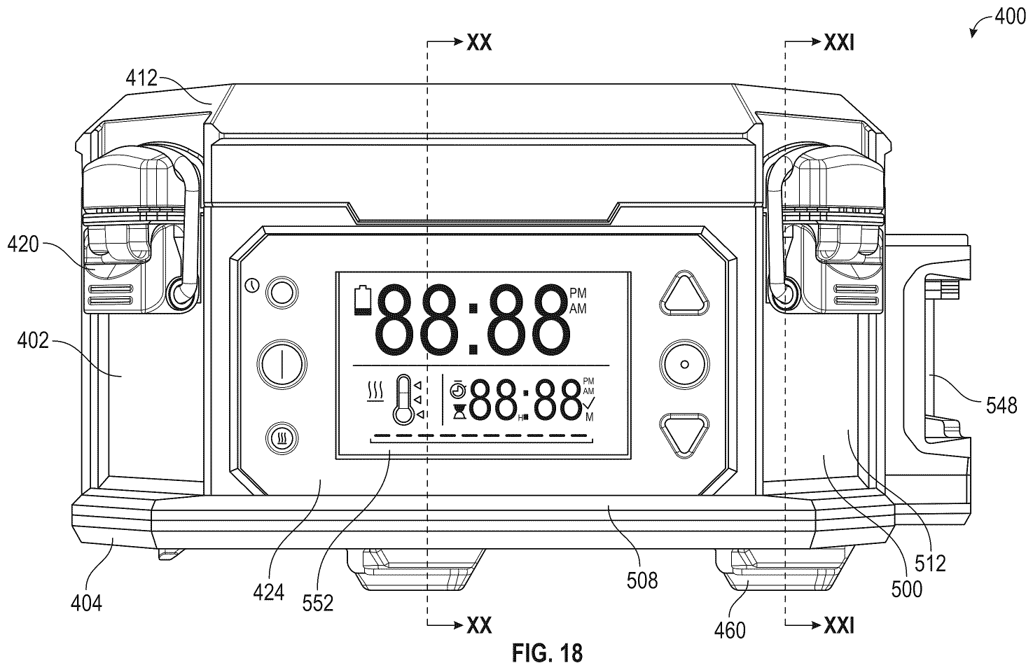

In some examples, the food carrying device 400 can include a user interface 424 configured to receive inputs from a user to control operation of the food carrying device 400. FIG. 18 illustrates a user interface 424 that can be disposed on one of the shell sidewalls 512 between the base 404 and the first end. The user interface 424 can receive inputs from a user to control a temperature and period of heating of the food carrying device 400. Inputs to the user interface 424 can activate, deactivate, or change a temperature of the heating element 452 to selectively warm a user's food stored within the food carrying device 400. The user interface 424 can communicate with the controller 468, which communicates with the battery 456 and the memory 434 (as also shown in FIG. 31). In some embodiments, the memory 434 (e.g., non-transitory computer readable memory) can store the user's preferences, such as temperature level, mealtime preferences, and period of activation of a heating element of the food carrying device 400 or can store activation algorithms (e.g., heating profiles) for the heating element 452. The controller 468 can include a processor capable of retrieving data from the memory 434 and executing the activation algorithms.

In some embodiments, as shown in FIG. 18, the user interface 424 can include buttons, switches, or levers to allow inputs to the user interface 424. In some cases, the user interface 424 can include an audible or tactile feedback mechanism, such as a beep or vibration, to confirm the user's input. The user interface 424 can be designed for easy operation and can include visual indicators such as LED lights or a display 552 to provide feedback to the user. The display 552 can communicate a status of the food carrying device 400, or a status of the user's food, to the user. For example, the user interface 424 can allow the user to select the power source (e.g., battery, USB port, other power port), and can display information about the current power source and power level. In some examples, the display 552 can provide additional visual feedback to the user, such as displaying an amount of time remaining in a food warming process.

More specifically, FIG. 18 illustrates that the food carrying device 400 can output information on the display 552 to communicate various statuses of the food carrying device 400 to the user. The display 552 can show the current heating mode, which can include options such as “quick heat,” “slow heat,” or “maintain temperature.” This information can allow the user to confirm the selected heating mode and adjust if needed. The display 552 can show the remaining battery charge, which can be presented as a percentage or graphical battery icon. In some examples, a controller 468 (as shown in FIG. 31) can output the current temperature of the food item or an interior volume 524 of the compartment 408 to the display 552, to allow users to monitor the heating progress. In some cases, the display 552 can show both the current temperature and the target temperature side-by-side for easy comparison. Furthermore, the controller 468 can calculate and output the estimated time remaining until the food item reaches the desired temperature on the display 552, e.g., to help users plan their mealtimes more effectively. Additionally, while the user is inputting a desired food temperature, desired mealtime, or desired period of heating into the user interface 424, the display 552 can show the total amount of time required to properly heat the food item retained by the food carrying device 400. In some examples, the display 552 can provide status updates on the heating process, such as “preheating,” “heating in progress,” or “temperature maintained,” to provide users a clear understanding of the current stage of the heating cycle.

The food carrying device 400 can include the storage compartment 408 for receiving and retaining food items or food containers. FIGS. 19-21 illustrate the first storage compartment 408 coupled to the shell 500 at the first shell end. For example, the first compartment 408 can be coupled to the shell 500 via press fit, snap-fit, adhesive, fasteners, overmolding, etc. In other embodiments, the first storage compartment 408 can instead be integrally formed with the shell 500. As shown in FIGS. 19-21, the first storage compartment 408 can include a compartment lip 516 that is coupled to and extends from the plurality of shell sidewalls 512. The compartment lip 516 can extend from the shell 500 at the first shell end toward an inside of the shell 500. The compartment lip 516 can circumscribe the first storage compartment 408 to define the open end 520 (e.g., an opening) of the first storage compartment 408.

As shown in FIGS. 20 and 21, the first storage compartment 408 can define an interior volume 524 that extends from the open end 520 to a compartment base 528, disposed between the open end 520 and the base 404. The interior volume 524 can be defined by the compartment base 528 and a plurality of compartment sidewalls 532 extending between the compartment base 528 and the open end 520. Referring briefly to FIG. 29, the interior volume 524 can define a substantially cuboid shape; however, the interior volume 524 can define any applicable shape, including cylindrical, a prism having any number of sides, or other applicable shapes. As described further below, the interior volume 524 can receive and secure containers that contain a user's food. However, in other examples, the interior volume 524 may directly receive food items, and no food container may be needed.

FIGS. 19-21 and 29 illustrate that the food carrying device 400 can include a food container 556. The food container 556 includes a container housing 560 defining an interior volume to store and receive the user's food. The container housing 560 extends from a container base to a container open end. The container open end is closed by a container lid 570. The container lid 570 can be secured to the container 556 by a plurality of container fasteners 564. Specifically, as shown in FIGS. 20 and 21, the container fasteners 564 can extend from the container lid 570 to engage a container lip 574 that extends around the open end of the container 556. The container fasteners 564 can include clamps, defining a hooked end that can engage the container lip 574. However, in other embodiments, the container lid 570 can be fastened to the container 556 via an alternate fastening mechanism, such as snap-fit connections, latches, press-fit engagements, or other suitable methods. In some examples, the container fasteners 564 may further act as grip points. For example, a user may lift a container assembly including the food container 556 and the container lid 570 by the container fasteners 564.

In some examples, as shown in FIGS. 20 and 21, the container lid 570 can include a container gasket 572. For example, when the container lid 570 is secured to the food container 556, the container gasket 572 can engage the food container 556 to form a seal. Specifically, the container gasket 572 can engage the container lip 574 to form a seal around the container open end to mitigate ingress and egress of fluid, food particles, contaminants, and other particulate into and out of the container 556.

The food container 556 can be received into the first storage compartment 408. That is, in the illustrated embodiment, the interior volume 524 of the first storage compartment 408 can be shaped to receive the container housing 560. The container housing 560 can contact the compartment base 528 or one or more of the compartment sidewalls 532. The close proximity of the container housing 560 to the compartment base 528 or one or more of the compartment sidewalls 532 can advantageously encourage heat flow from the heating element 452 to the food items stored in the food container 556.

Additionally, in some embodiments, the container 556 can extend from the compartment base 528 beyond the open end 520 of the interior volume 524 of the first storage compartment 408, to allow users to easily grab and remove the container 556 from the first storage compartment 408, for example, for eating, cleaning, refilling, or replacement. Specifically, as illustrated in FIGS. 19-21, the container lid 570 or the container lip 574 can extend over the compartment lip 516 to ensure easy removability of the container 556. In such examples, a gap may separate the container fasteners 564 from the open end 520 or from the compartment lip 516 to provide easy access for the user to grip the container fasteners 564 (e.g., or handles thereon) to remove the container assembly from the first storage compartment 408.

FIGS. 20 and 21 illustrate that the compartment sidewalls 532 and the compartment base 528 can be hollow. The hollow compartment sidewalls 532 and compartment base 528 can define housing void(s) 536 that can be filled with an insulating foam to create the insulation layer 504. In some embodiments, the insulation layer 504 may instead include a vacuum in the housing void(s) 536, or may otherwise include the housing void(s) 536 filled with an air or gas. The insulation layer 504 can function as a heat insulator, allowing for efficient heating of the food within the first storage compartment 408, and long-lasting heat retention.

In other embodiments, the housing void(s) 536 can be formed between the first storage compartment 408 and the shell 500. Specifically, the housing void(s) 536 can be defined between the shell sidewalls 512 and the compartment sidewalls 532, as well as between the shell base 508 and the compartment base 528. As above, the void(s) 536 can be filled with an insulating foam to create the insulation layer 504.

In some embodiments, the shell 500 can provide a protective barrier around the insulation layer 504, the first storage compartment 408, and other internal components of the food carrying device 400, to ensure the food carrying device 400 is durable and resistant to drops or other such blunt force incidents. Specifically, in some embodiments, the material of the shell 500 can comprise a metal, ceramic, plastic, or other applicable durable material.

In some embodiments, the material of the first storage compartment 408 can comprise a metal, ceramic, or plastic to protect the insulation layer 504 and other internal components of the food carrying device 400 from objects placed within the food carrying device. As the first storage compartment 408 can be subjected to heat and the spillage of food items, the first storage compartment 408 can include a heat-resistant material and can include a non-stick surface for easy cleaning. Although the present embodiment illustrates the insulation layer 504 comprising foam insulation, in other embodiments, the insulation layer 504 can comprise fiberglass, ceramic, silicone, or other applicable insulating materials.

FIGS. 20 and 21 further illustrate that, in some embodiments, the lid 412 can define a lid void 540. Similar to the void 536 discussed above, the lid void 540 can be filled with an insulating foam to create a lid insulation layer 544. Although the present embodiment illustrates the lid insulation layer 504 comprising foam insulation, in other embodiments, the lid insulation layer 544 can comprise fiberglass, ceramic, silicone, or other suitable insulating materials. In some embodiments, the lid insulation layer 544 may instead include a vacuum in the lid void(s) 540, or may otherwise include the lid void(s) 540 filled with an air or gas. As described further below, the lid insulation layer 544 can also advantageously mitigate heat transfer through the lid 412, when the lid 412 is used as a tray for a food container of the food carrying device 400. The lid 412 can define a protective barrier around the lid insulation layer 504 to mitigate damage to the insulation layer 544.

As shown in FIGS. 20 and 21, the lid 412 can enclose the container 556 and close the open end 520 of the interior volume 524. The lid 412 can further define a lid interior volume 578 to receive a portion of the food container 556. Specifically, when the lid 412 is in a closed configuration over the first storage compartment 408, the food container lid 570 and portions of the container housing 560 can extend into the lid interior volume 578. In some embodiments, a shape of the lid interior volume 578 can conform to a shape of the food container lid 570. These configurations can provide a secure fit over the container 556 and reduce movement of the container 556 relative to the first storage compartment 408 and the lid 412 during transport.

Referring again to FIGS. 20 and 21, in some embodiments, the lid 412 can include a gasket or a seal that can engage the container 556 when the lid 412 is in the closed configuration. The gasket or seal can be disposed within the lid interior volume 578 and can be configured to resiliently deform against the container 556 (e.g., the container lid 570) to mechanically secure the container 556 within the storage compartment 408 during transport. Specifically, the gasket or seal can advantageously reduce unwanted movement during transport of the food carrying device 400.

FIGS. 20 and 21 illustrate that the heating element 452 of the food carrying device 400 can extend around the interior volume 524 of the first storage compartment 408 to allow the heating element 452 to heat the first storage compartment 408, and food items disposed within the container 556 disposed therein, when activated. In the present embodiment, the heating element 452 is disposed along the compartment base 528. However, the heating element 452 can instead extend along the compartment sidewalls 532, along the lid 412, or along a combination of the compartment base 528, the compartment sidewalls 532, and the lid 412, and/or within or along the container 556 itself. As illustrated in the present embodiments, the heating element 452 can be disposed in the void(s) 536 and can be situated between the insulation layer 504 and the interior volume 524. In some embodiments, the heating element 452 can be disposed in one of the void(s) 536 that is separate from the void 536 housing the insulation layer 504 in order to reduce contact between the heating element 452 and the insulation layer 504.

In some examples, the heating element 452 of the food carrying device 400 can be disposed within the lid 412 or along an interior surface of the lid 412. For example, the heating element 452 can be disposed in the lid void(s) 540. In some embodiments, the heating element 452 can be disposed in one of the lid void(s) 540 that is separate from the lid void 540 housing the lid insulation layer 544 in order to reduce contact between the heating element 452 and the lid insulation layer 544. In some embodiments, one or more of the heating elements 452 can be disposed in two or more locations within or along the first storage compartment 408 and the lid 412 to provide even heating to the first storage compartment 408. Activating the heating element 452 can increase the temperature of the interior volume 524 to heat up a food item stored within the interior volume 524 and the container 556.

Referring briefly back to FIG. 19, in some embodiments, the lid 412 can receive the container 556 to function as a tray for the user during mealtime. For example, as illustrated in FIG. 19, in the open configuration, the lid 412 can be positioned substantially horizontal, e.g., parallel to a ground plane, or other support surface, on which the food carrying device 400 rests. When in this configuration, the container 556 can be received and secured within the lid interior volume 578. In such examples, the lid 412, and therefore the container 556, can be supported by the handle 444 extending from the lid 412. More specifically, the handle 444 can be rotated or otherwise positioned to extend substantially perpendicular from, or at another angle from, the lid 412 to contact the ground plane, or other support surface, on which the food carrying device 400 rests, and support the lid 412 relative thereto. The handle 444 can therefore act as a stabilizer, to ensure the food carrying device 400, and therefore the food container 556 resting on the lid 412, stays in an upright position while the user enjoys their meal. As such, when rotated to stabilize the lid 412, the handle 444 can be substantially locked from moving due to a friction hinge arrangement or other suitable locking mechanism.

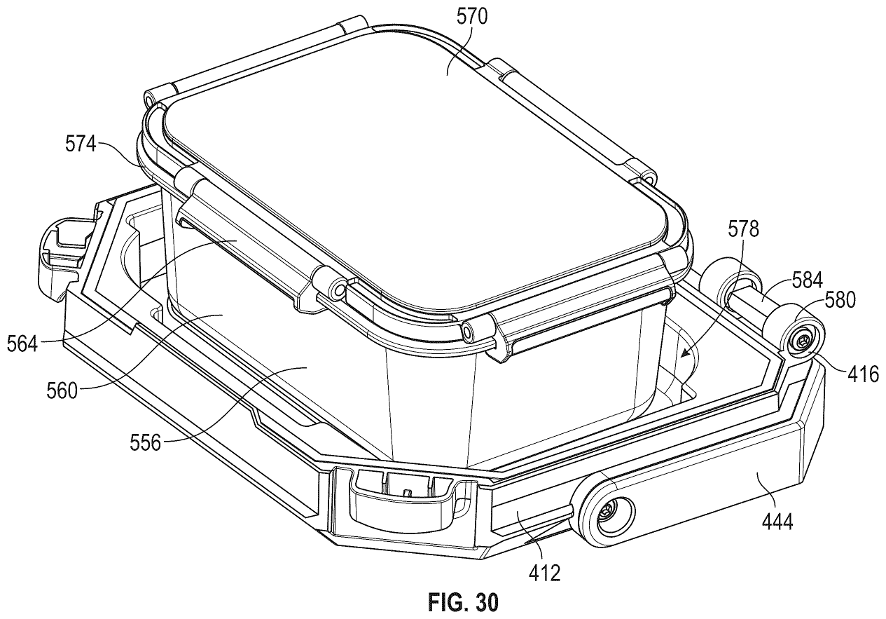

In some embodiments, the lid 412 can be selectively removable from the housing 402 or the shell 500. Often, workers in the field do not have access to a table or other surface to place food containers during mealtimes. This generally means that food containers are placed directly on the lap of the user while the user is eating from the food container. However, users that place food containers on their laps might experience heat emanating from the food container, which could potentially cause discomfort for the user. Accordingly, as illustrated in FIG. 30, the lid 412 can be usable as a tray to insulate a user's lap or other body part (or other surface) from any heat radiating from the food stored in the container 556 after the food is warmed by the food carrying device 400. In some examples, the heating element 452 can be disposed within or along the lid 412, allowing the lid to continue to act as a warming pad or hotplate for the food stored in the container 556 while the user is eating their meal.

In some embodiments, the lid 412 is coupled to the shell 500 or housing 402 by the lid hinge 416. FIGS. 19 and 21 illustrate that the lid hinge 416 can include, for example, a butt hinge, a barrel hinge, an offset hinge, etc. In the present embodiment, the lid hinge 416 can include one or more housing barrels 576 that extend from one of the shell sidewalls 512 of the housing 402. The housing barrels 576 can be disposed adjacent the first shell end, opposite the base 404. The lid hinge 416 can further include two or more lid barrels 580 that extend from the lid 412. Additionally, one or more pins 584 can extend between two or more adjacent lid barrels 580 (as illustrated in FIG. 30). Each of the pins 584 can be received within one or more of the housing barrels 576 to rotatably couple the lid 412 to the housing 402. In some embodiments, the pins 584 can extend integrally between one or more of the lid barrels 580, however, in other embodiments the pins 584 extend through and are coupled to the lid barrels 580.

FIG. 21 illustrates that the housing barrels 576 can each define a channel 588 that extends in an axial direction between a first barrel open end and a second barrel open end, opposite the first barrel open end. Furthermore, one of the lid barrels 580 can be disposed at both the first- and second-barrel open ends of each of the housing barrels 576. In some embodiments, the channels 588 of the housing barrels 576 can each include a slit 592 that extends parallel to the axial direction from the first barrel open end to the second barrel open end. As described further below, the channels 588 of the housing barrels 576 can retain the pins 584 when the lid 412 is in a closed configuration, but can further allow the pins 584 to exit the channels 588 via the slits 592 when the lid 412 is in an open configuration, so that the lid 412 can be decoupled from the first storage compartment 408.

FIG. 21 illustrates that, in some embodiments, a cross-sectional shape of each of the channels 588 (e.g., perpendicular to the axial direction) can be substantially circular. As illustrated in FIG. 21, a perimeter of the cross-sectional shapes of each the channels 588 can be interrupted by one of the slits 592 extending along the housing barrels 576. The slits 592 can create a slit opening 596 in the cross-sectional shapes of each of the channels 588 that extends less than about ¼ or less than about ⅓ of the perimeter of each of the channels 588.

In some embodiments, a cross-sectional shape of each of the pins 584 (e.g., perpendicular to the axial direction) can be substantially a stadium shape (e.g., a rectangle with opposing rounded sides). Alternatively, the cross-sectional shape of each of the pints 584 may be rectangular. As illustrated in FIGS. 21-29, during rotation of the lid 412 the rounded sides of the cross-sectional shape of each of the pins 584 can generally engage and be rotatable within the cross-sectional shapes of the channels 588. In some embodiments, a minimum width of the stadium shape (e.g., a width between opposing straight sides of the stadium shape) can be less than a width of the slit opening 596. The described cross-sectional shape of the pins 584 can allow the pins 584 to exit the channels 588 via the slits 592, to decouple the lid 412 from the housing 402.

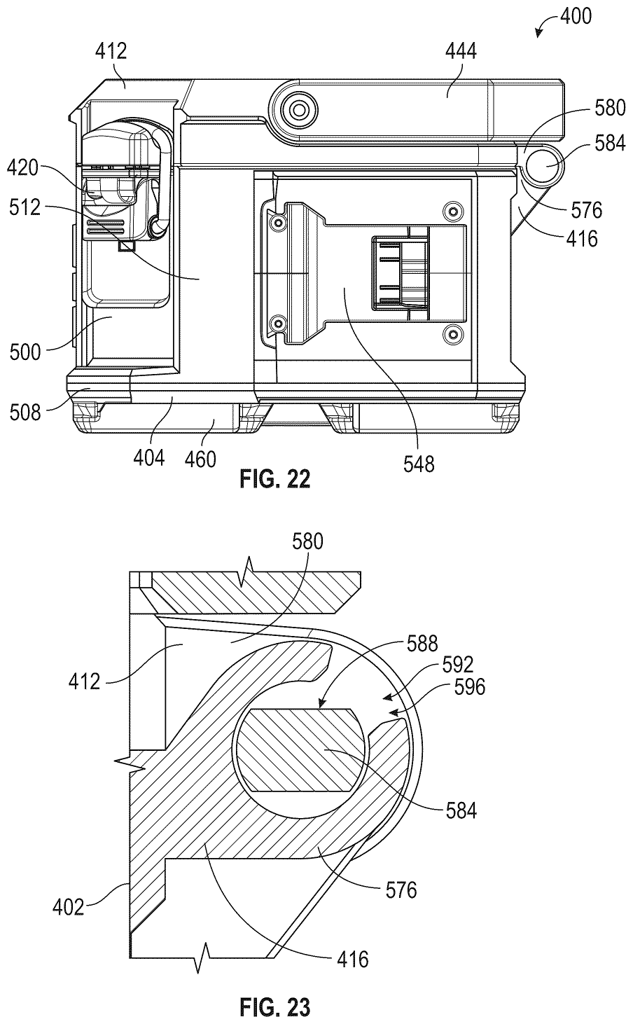

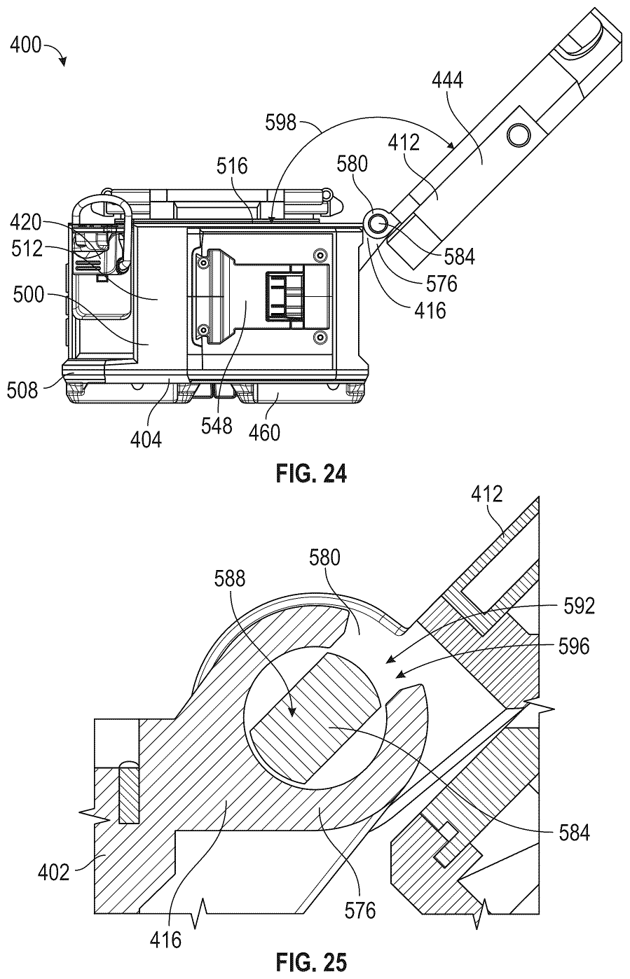

More specifically, FIGS. 22-29 illustrate an example process of detaching the lid 412 from the housing 402. FIGS. 22 and 23 illustrate the lid 412 in a closed configuration. Referring to FIGS. 24 and 25, as the user lifts the lid 412, the lid 412 can rotate about the lid hinge 416 to an open configuration. When the lid 412 reaches a predetermined angle relative to the housing 402, the pins 584 extending channels 588, can align with the slits 592 of the housing barrels 576. Specifically, the pins 584 can be aligned with the slits 592, so that the minimum width of the cross-sectional shape of the pins 584 is aligned with the slits 592.

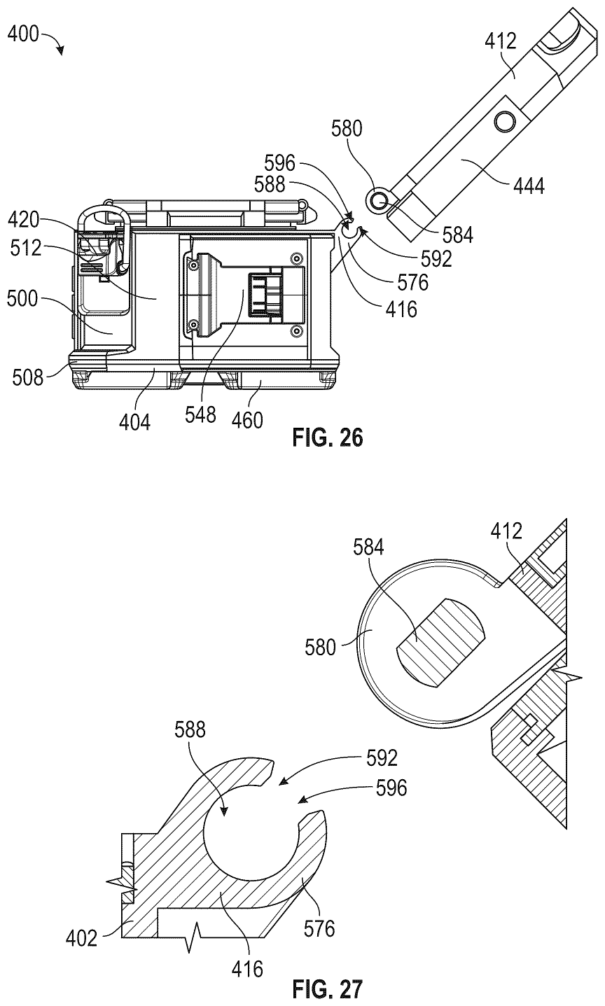

FIGS. 26 and 27 illustrate that once the pins 584 and the slits 592 are properly aligned, the user can decouple the lid 412 from the housing 402 by pulling the lid 412 away from the housing 402, causing the pins 584 to exit the channels 588 through the slits 592. In some examples, the pins 584 and the slits 592 can be properly aligned when the lid 412 is opened to a predetermined angle 598, as shown in FIG. 24. More specifically, the pins 584 and the slits 592 can be properly aligned when a base lid wall of the lid 412 (e.g., a bottom surface of the lid 412 relative to gravity in the closed configuration that can engage a compartment lip 516 of the shell 500 when the lid 412 is in the closed configuration) forms the predetermined angle 598 with the compartment lip 516 (e.g., or a top surface of the shell 500 relative to gravity). In some examples, the predetermined angle 598 can be about 135 degrees. However, in other examples, the predetermined angle 598 can be between about 130 degrees and about 140 degrees, or between about 125 degrees and about 150 degrees.

Although the illustrated example shows the channels 588 having substantially circular cross-sectional shapes, and the pins 584 having substantially stadium shaped cross-sectional shapes, a similar rotational engagement and detachment mechanism between the lid 412 and the housing 402 can be achieved with the channels 588 and the pins 584 that have other suitable cross-sectional shapes. For example, the pins 584 can define an ovular cross-sectional shape, or other suitable oblong cross-sectional shapes.

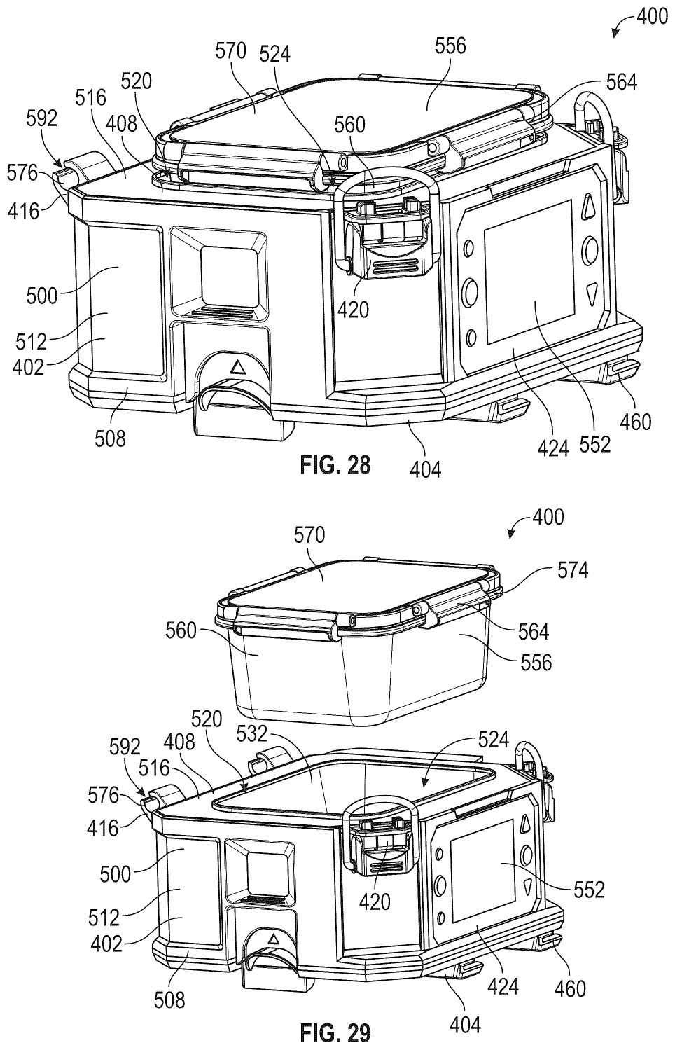

FIGS. 28-30 illustrate that once the lid 412 is detached or opened, the user can place the food container 556 on the detached lid 412. The removable nature of the lid 412 can allow it to serve as a separate surface for holding food or eating, providing added convenience for users in various environments. Furthermore, in some examples, the lid 412 can include lid engagement features that can selectively receive or secure a cup, mug, or other liquid container. The lid engagement features can be disposed along an exterior side of the lid 412, or along an interior side of the lid 412 (e.g., within, along, or adjacent to the lid interior volume 578). The lid engagement features can include a recess that can receive and hold a base of the liquid container. In other examples, the lid engagement features can include male or female couplers or fasteners that can engage male or female couplers or fasteners on the liquid container. The lid engagement features can therefore allow the lid 412 to conveniently retain both the food container 556 and the liquid container while a user uses both during mealtimes.

FIG. 31 illustrates a schematic view of the food carrying device 400. For example, FIG. 31 illustrates that the heating element 452 can be electrically connected to the controller 468. The controller 468 regulates the amount of power delivered to the heating element 452 based on user inputs to the user interface 424. The user interface 424 (as shown in FIG. 18) can be connected to the controller 468 and can allow a user to control various functions of the food carrying device 400, such as setting the desired temperature and period of activation of the heating element 452. Inputs to the user interface 424 can be received by the controller 468, which in turn can activate the heating element 452. The controller 468 can further activate the display 552 to communicate a status of the food carrying device 400 to the user.

The controller 468 can monitor the status of the food carrying device 400 via a plurality of sensors 600. The plurality of sensors 600 can include one or more temperature sensors to determine a temperature of the first storage compartment 408, determine a temperature of the heating element 452, determine an ambient temperature of the ambient environment, and/or determine a temperature of the battery 456 or other components therein. The plurality of sensors 600 can further include a voltage sensor, an impedance sensor, and/or and other battery testing sensors, to determine an amount of charge remaining in the battery 456 (e.g., an amount of energy stored in the battery 456) and an amount of power or voltage being applied to the heating element 452.

In some examples, the user interface 424 can also provide options for users to select different heating modes, such as “quick heat,” “slow heat,” “low heat”, “high heat,” or “medium heat” which can correspond to different power output profiles for the heating element 452. In such embodiments, the user interface 424 can allow the user to set a timer for the heating operation. The timer may be configured to control the period of activation of the heating element 452, providing users with precise control over heating cycles. In some examples, when the timer expires, the controller 468 can deactivate the heating element 452. In other examples, the controller 468 may reduce a heating level of the heating element 452 when the timer expires (e.g., from high heat to low heat) to ensure the food item remains warm. In some embodiments, the user interface 424 can inform the user when the timer expires through various notification methods. In some cases, the display 552 can show a visual indication such as a flashing message, countdown completion notification, or status change indicator. The user interface 424 may also provide audible alerts, such as beeps or tones, to notify the user that the heating cycle has completed. In some embodiments, the device can provide tactile feedback through vibration to alert users when the timer has expired. These notification features can help users manage their meal timing and ensure food is heated for the appropriate period of time without requiring constant monitoring of the device. In some embodiments, the controller 468 may similarly notify a user and reduce a heating level of the heating element 452, or deactivate the heating element 452, when a heating profile, as described further below, is complete.

In further embodiments, the food carrying device 400 may include a wired or wireless communication module (not shown), such as a Bluetooth® module. The controller 468 can communicate various notifications of the food warming device 400 to a remote device, such as a user phone or tablet, via a wired or wireless connection with the remote device through the communication module. As such, a user may be able to remotely view an output of the digital display of the user interface 424 via the remote device and/or remotely provide user inputs via the remote device.

In some embodiments, the user interface 424 can allow the user to command the food carrying device 400 to either heat a food item to a certain temperature in a specified amount of time (e.g., one hour) or heat a food item to a certain temperature by a specified time (e.g., by noon). In such examples, the controller 468 can choose or calculate a heating profile based on the inputs to the user interface 424. In other examples, the memory 434 can store a plurality of heating profiles that the controller 468 can implement based on the user's inputs to the user interface 424. Heating profiles can include at least an activation level (or heating level) of the heating element 452 (e.g., a voltage applied to the heating element 452) and a period of activation of the heating element 452. As described further below, heating profiles can also include a sequence of two or more of the activation levels, each lasting for a period of activation.

In some examples, the controller 468 can utilize data acquired from the sensors 600 to calculate or to choose a heating profile. For example, utilizing data from the sensors 600, the controller 468 can calculate a heating profile for heating the food item. In some examples, the controller 468 can utilize algorithms that take into account factors such as an initial food temperature, desired final temperature, thermal properties of the food container 556, as well as a temperature of storage compartment 408 and an ambient temperature to optimize the heating process. For example, the controller 468 can determine the initial temperature of the food item, or the storage compartment 408, and the ambient temperature using the sensors 600. By analyzing the temperature differential between the food item or the storage compartment 408 and the desired serving temperature, the rate at which heat might escape the storage compartment 408 based on the ambient temperature, and/or the time available until the specified mealtime, the controller 468 can optimize the heating profile to achieve the target temperature efficiently while conserving battery power. For example, if the difference between the food item temperature and the desired serving temperature is large, the controller 468 may choose a heating profile having higher activation level(s) or longer period(s) of activation.

In some embodiments, the controller 468 can adjust the activation level and period of activation of the heating element 452 based on the user's input to the user interface (e.g., a user's requested food ready time or heat mode). When the requested mode is quick heat or the food ready time is soon, the controller 468 can apply a high voltage to the heating element 452 at a high activation level to quickly raise the temperature of the heating element 452 and consequently the food item. This rapid heating can allow the food to reach the desired temperature or user inputted temperature within a shorter timeframe. Conversely, when the requested food ready time is further in the future, the controller 468 can apply a comparably lower voltage to the heating element 452 at low activation level over a longer period of activation. This gradual heating approach can allow for more energy-efficient operation and potentially more even heating of the food item.

In some cases, the controller 468 can implement a variable heating profile, where the activation level, and the voltage applied to the heating element 452, is adjusted dynamically over time. In some examples, the variable heating profile can include an initial high activation level for a first period of activation to raise the heating element 452 and food temperature, followed by a lower activation level for a second period of activation to maintain the desired temperature of the food until the desired mealtime. In other examples, the variable heating profile can include an initial low activation level for a first period of activation, followed by a high activation level for a second period of activation to increase the food item to the desired temperature by the requested ready time.

For example, if a user sets a mealtime that is several hours in the future, the controller 468 may implement a variable heating profile with multiple activation phases. During a first period of activation, the activation level of the heating element 452 may be set to a first activation level. The first activation level can include zero voltage, or an otherwise low voltage, applied to the heating element 452, effectively maintaining the current temperature of the food item and the storage compartment 408 without additional heating. This approach may conserve battery power when immediate heating is not required. During a second period of activation, the activation level of the heating element 452 may be set to a second activation level, which is higher than the first activation level. During this phase, the food may be warmed to the desired temperature by the desired mealtime. In some examples, the controller 468 can calculate the timing, length, and intensity of the second activation level and the second period of time based on the desired temperature, current food temperature, time remaining until the specified mealtime, or other applicable factors (e.g., listed above). In other examples, the controller 468 may instead utilize a second period of activation (e.g., 30 minutes, 1 hour, 2 hours, or another applicable amount of time) and a second activation level (e.g., a specific voltage) that can be stored in the memory 434.

In some examples, the food carrying device 400 may power off after the second period of activation to conserve battery life once the target temperature has been achieved. In other examples, the food carrying device 400 may continue to a third period of activation where the activation level of the heating element 452 may be set to a third activation level. The third activation level can be equal to or lower than the second activation level. This third activation level may provide a maintenance heating function to keep the food at the desired temperature. The third period of activation can last until the user powers off the device, ensuring the food remains warm for consumption whenever the user is ready to eat. However, in other examples, the third period of activation can be a preset amount of time (e.g., 15 minutes, 30 minutes, or another applicable amount of time) in order to conserve power.

In some embodiments, the controller 468 may implement a hysteresis cycle to maintain the desired temperature within the storage compartment 408. The hysteresis cycle may provide temperature regulation by cycling the heating element 452 between active and inactive states based on temperature feedback from the sensors 600. When temperature data from the sensors 600 informs the controller 468 that the desired temperature has been achieved, the controller 468 may deactivate the heating element 452 to conserve battery power. The controller 468 may monitor the temperature within the storage compartment 408 through the sensors 600. When the sensors 600 detect that the temperature has dropped below a first threshold level, the controller 468 may reactivate the heating element 452. The first threshold level may be set at a predetermined offset below the desired temperature, such as between about 5 and about 10 degrees Fahrenheit below the target temperature. Upon reactivation, the heating element 452 may operate until the temperature within the storage compartment 408 reaches the desired temperature again. This cycling process may repeat continuously, creating a hysteresis loop that maintains the food temperature within an acceptable range around the desired setpoint. The hysteresis cycle may increase efficiency of the food carrying device 400 and decrease power consumption. In some cases, the controller 468 may adjust the hysteresis band based on factors such as ambient temperature, desired temperature, battery charge level, or user preferences.

In some embodiments, the controller 468 may implement a pulsed heating profile, where the heating element 452 alternates between periods of activation and deactivation in a cyclical pattern. The pulsed heating profile may include bursts of high-intensity heating followed by deactivation periods. The period and intensity of each pulse may be adjusted based on ambient temperature, desired temperature, battery charge level, user preferences, or other applicable factors.

In some cases, the controller 468 may implement a dual-zone heating profile that activates different portions of the heating element 452 at different times or intensities. For example, heating elements positioned at the bottom of the storage compartment 408 may operate at a higher activation level initially, while heating elements on the sides may activate later in the heating cycle to provide more uniform temperature distribution throughout the food item. Further, in such cases, the controller 468 may cycle through heating different portions of the heating element 452 to provide more uniform temperature distribution through the food item.

In some embodiments, the user interface 424 may allow the user to select a type of food being prepared for heating within the food carrying device 400. The user interface 424 may provide options for various food categories, such as soup, meat, sandwich, vegetable, pizza, or other food types. The food type selection may be presented through menu options on the display 552, allowing users to navigate through different food categories using buttons or touch controls on the user interface 424. In some cases, the user interface 424 may include preset buttons or icons that correspond to common food types, enabling quick selection without navigating through multiple menu levels.

In some aspects, the memory 434 may store a plurality of heating profiles that are specifically tailored to different types of food being prepared. Each food type may have unique thermal characteristics that require different heating approaches for optimal results. For example, soup and other liquids may require prolonged heating. Meat products may benefit from higher initial heating levels followed by lower maintenance temperatures to achieve proper warming. Furthermore, sandwiches and pizza may benefit from moderate heating levels to warm the contents without making the bread or crust overly dry.

The controller 468 may implement the appropriate heating profile based on the food type selected by the user through the user interface 424. When a user selects a specific food type, the controller 468 may retrieve the corresponding heating profile from the memory 434 and execute the heating sequence accordingly. In some cases, the controller 468 may combine the food type heating profile with other user inputs, such as desired mealtime or heating mode, to create a customized heating sequence that accounts for both the food characteristics and user preferences.

In some embodiments, the user interface 424 may allow the user to input a quantity of a food item being heated within the food carrying device 400. The user interface 424 may provide input options for specifying food quantity in various units of measurement, such as pounds, ounces, grams, kilograms, pieces, servings, or other applicable quantity measurements. The quantity input may be presented through numerical entry fields on the display 552, allowing users to enter specific values using buttons or touch controls on the user interface 424. In some cases, the user interface 424 may include preset quantity options or slider controls that correspond to common serving sizes, enabling quick selection without requiring precise numerical input. Alternatively, in some applications, one of the sensors 600 may be configured to determine a weight of the container 556 or a food item within the compartment 408. In such applications, the controller 468 can automatically determine a weight of the food item.

In some aspects, the memory 434 may store a plurality of heating profiles that are specifically tailored to different quantities of food being prepared. Each quantity range may have unique thermal requirements that necessitate different heating approaches for optimal results. For example, smaller quantities of food may require shorter heating periods and lower activation levels to prevent overheating, while larger quantities may benefit from extended heating periods and higher activation levels to ensure uniform temperature distribution throughout the food mass. The heating profiles may account for the thermal mass of different food quantities, recognizing that larger amounts of food may retain heat longer and require different heating strategies compared to smaller portions.

The controller 468 may calculate and implement heating profiles based on the food quantity input by the user through the user interface 424. When a user specifies a particular food quantity, the controller 468 may retrieve the corresponding heating profile from the memory 434 or calculate a customized heating profile based on the quantity parameters. The controller 468 may utilize algorithms that factor in the thermal mass of the specified food quantity, the surface area to volume ratio, and the expected heat transfer characteristics to optimize the heating process. In some cases, the controller 468 may combine the quantity-based heating profile with other user inputs, such as food type, desired temperature, or mealtime, to create a comprehensive heating sequence that accounts for both the amount of food and other relevant characteristics.

In some embodiments, the controller 468 can calculate the amount of power required to heat the food item to the desired temperature within the specified timeframe, or an amount of energy required to power the heating element until the desired mealtime. This calculation can take into account various factors such as the initial temperature of the food item, the thermal properties of the food container 556 and the interior volume 524, the ambient temperature, the heating profile being used to heat the food item, as well as the efficiency of the heating element 452. The controller 468 can use thermal modeling algorithms to estimate the heat transfer rate and energy requirements for achieving the desired food temperature.

In some embodiments, the controller 468 can receive data from the plurality of sensors 600 to determine the amount of charge remaining in the battery 456, or an amount of energy stored in the battery 456. Determining the amount of charge remaining in the battery 456 can involve measuring the battery voltage, current draw, or internal resistance. The controller 468 can also consider factors such as ambient temperature, battery age, temperature, and previous usage patterns to refine the estimate of the available charge. In other embodiments, the controller 468 can receive information related to the amount of charge remaining in the battery 456 directly from the battery 456 (e.g., or a controller of the battery 456).

Once the controller 468 has calculated the power or energy required for heating the food item to the desired temperature and determined the available battery charge or energy, the controller 468 can compare these values to assess whether the heating operation can be completed using the current charge within the battery 456. In some embodiments, the controller 468 can factor in a safety margin to account for potential variations in power consumption or unexpected energy losses.

In cases where the calculated power requirement exceeds the available charge in the battery 456, the food carrying device 400 can alert the user to exchange the battery 456 for a different battery or connect the food carrying device 400 to a different power source. This alert can be communicated through various methods, such as: 1) displaying a message via the user interface 424; 2) activating a visual indicator (e.g., a flashing LED or a symbol on the display 552); 3) emitting an audible alert or series of beeps; or 4) sending a notification to a connected mobile device. The alert can include information about the amount of charge lacking in the battery 456, to allow the user to make an informed decision about whether to exchange the battery 456, adjust the heating parameters, or connect the food carrying device 400 to an alternative power source. In some embodiments, the food carrying device 400 can suggest alternative heating profiles that could be achieved with the current battery charge by way of the display 552, providing the user with options to proceed without immediately exchanging the battery 456.

While the above description provides various automatic operations by the controller 468, in some examples, the food carrying device 400 can allow a user to input manual heating instructions, such as “heat on,” “heat off,” “low heat on,” “high heat on,” etc. In response, the controller 468 may control the heating element 425 according to the manual heating instruction.

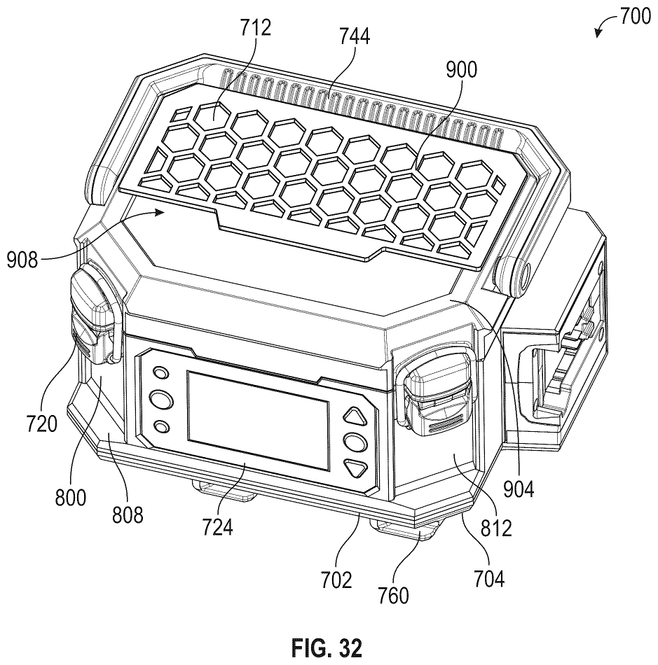

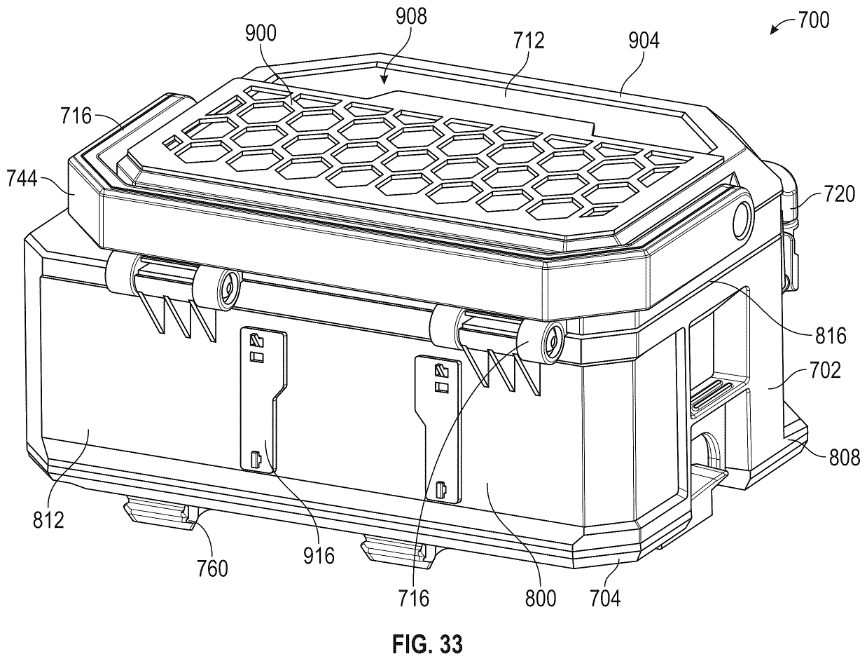

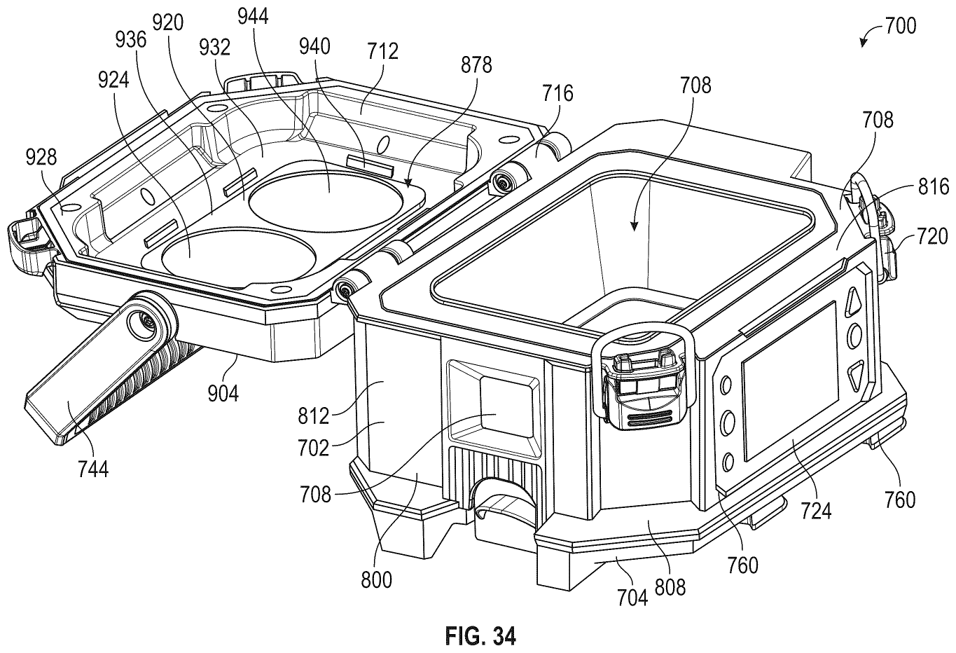

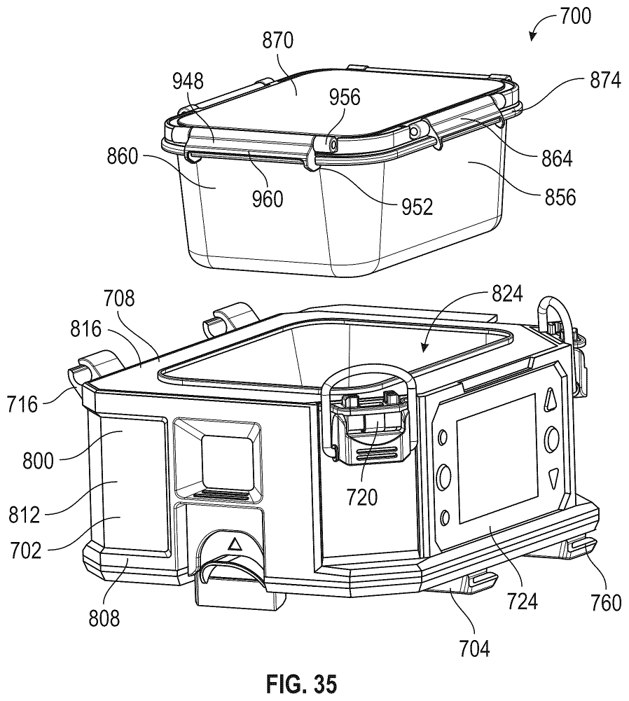

FIGS. 32-35 illustrate another embodiment of a food carrying device 700. The food carrying device 700 of FIGS. 32-35 can generally include similar features as the food carrying device 100 of FIGS. 1-6, the food carrying device 200 of FIGS. 7-14, and the food carrying device 400 of FIGS. 15-31, including but not limited to a housing 702, a base 704, a first storage compartment 708 (e.g., a tray, shown in FIG. 34), a lid 712, a lid hinge 716 (shown in FIGS. 33-35), a fastening mechanism 720, a user interface 724, a memory, a handle 744, a heating element, a battery, engaging features or feet 760, a controller, a shell 800, a shell base 808, shell sidewalls 812, and, as shown in FIG. 35, an interior volume 824, a food container 856, a container housing 860, container fasteners 864, a container lid 870, and a lid interior volume 878 (shown in FIG. 34). Thus, discussion of the food carrying devices 100, 200, 400 above also generally applies to similar components of the food carrying device 700 (and vice versa).

Referring to FIG. 32, in some examples, the food carrying device 700 can include a compartment for securing and retaining components such as utensils, tissues, tools, condiments, phones, or other applicable tools and components. In some examples, the component compartment can be disposed on the lid 712 of the food carrying device 700. For example, as illustrated in FIG. 32, the lid 712 can include a mesh 900 or a netting. The mesh 900 can extend across a top lid wall 904 of the lid 712 (e.g., a surface of the lid 712 opposite the lid interior volume 878) and can form a pocket for storing and securing the components.

The mesh 900 can be secured to the lid 712 using a plurality of fasteners. For example, the mesh 900 can be secured to the lid 712 using buttons, tabs, screws, hook and loop fasteners, or other applicable fasteners. In another example, the mesh 900 can be secured to the lid 712 using a suitable adhesive. In some examples, the mesh 900, or at least a portion of the mesh 900, can be removably or fixedly secured to the lid 712. In some examples, the mesh 900 can be a shape memory material or a resiliently deformable material and can resiliently retain the components against the lid 712. For example, the mesh 900 can be a silicon, a nylon, or another applicable textile or rubber material.

In some examples, the lid 712 can include a top lid recess 908. For example, the top lid recess 908 can provide a surface for resting utensils, tissues, tools, condiments, phones, or other applicable tools and components. In some examples, the top lid recess 908 can be disposed along the top lid wall 904. Furthermore, the mesh 900 can extend across the top lid recess 908 to form the pocket for retaining the components. In such examples, the top lid recess 908 may include a raised perimeter. Furthermore, the mesh 900 can be coupled to the raised perimeter to offset the mesh 900 relative to a surface of the top lid recess 908, creating the pocket for the components therebetween.

Referring to FIG. 33, in some examples, the food carrying device 700 can include one or more straps 916 for securing components to the food carrying device 700. For example, the straps 916 can secure and retain utensils, tissues, tools, condiments, phones, or other applicable tools and components against an exterior of the housing. In some examples, straps 916 can extend along the shell 800. Specifically, the straps 916 can extend along an exterior surface of the sidewalls 812 of the shell 800, and can be configured to secure components against the exterior surface of the sidewalls 812.

As illustrated in FIG. 33, the straps 916 can be fixedly secured to the shell 800 at a first end of the straps 916 and can be removably secured at a second end of the straps 916, opposite the first end (e.g., via a suitable fastener, such as buttons, tabs, screws, hook and loop fasteners, etc.). In such examples, the straps 916 can be selectively disconnected from the shell 800 at the second end of the straps 916 to ease the insertion of the components between the straps 916 and the shell 800. In other examples, both ends of the straps 916 may be removably secured to the shell 800 or both ends of the straps 916 may be fixedly secured to the shell 800.

According to one example, as illustrated in FIG. 33, the straps 916 can be fastened to the shell 800 by tabs that extend outwardly from the shell 800. In such examples, the tabs can extend from the shell 800 through eyelets of the straps 916. However, in other examples, the straps 916 can be otherwise secured to the shell 800.

Referring to FIG. 34, as described above, the lid 712 can act as a tray during mealtimes for receiving the food container 556. In some examples, the lid 712 can further be configured to receive and retain fluid reservoirs such as bowls, cups, bottles, and other dishware having other shapes and sizes. Specifically, the lid interior volume 878 can include a plurality of different recesses for receiving and retaining food and fluid containers of different shapes and sizes. In such examples, the lid interior volume 878 can include a primary container port 920 and one or more secondary container ports 924.

As illustrated in FIG. 34, the lid interior volume 878 extends from a lid base wall 928 of the lid 712 (e.g., a surface of the lid 712 disposed opposite the top lid wall 904 that can engage a compartment lip 816 of the shell 800 when the lid 712 is in the closed configuration) toward the top lid wall 904 to a lid interior volume surface 932. In some examples, the primary container port 920 can be disposed along the lid interior volume surface 932. For example, the primary container port 920 can extend from the lid interior volume surface 932 toward the lid base wall 928 to a primary port surface 936. As such, the primary port surface 936 can be raised relative to the lid interior volume surface 932. However, in other examples, the primary container port 920 can extend from the lid interior volume surface 932 toward the top lid wall 904 to the primary port surface 936 that can be recessed relative to the lid interior volume surface 932.

In some examples, a perimeter of the primary container port 920 can define a rectangular or rounded rectangular shape (e.g., a rectangle having rounded corners). However, in other examples, the primary container port 920 can define a perimeter having other applicable shapes (e.g., square, circular, triangular, hexagonal, or other applicable shapes). Furthermore, the primary container port 920 may include one or more protrusions 940 that may extend from or adjacent to the perimeter of the primary container port 920 toward the lid base wall 928 (e.g., from the lid interior volume surface 932). The protrusions 940 can define vertical sides of the primary container port 920 and can aid the reception and retention of food or liquid containers in the primary container port 920.

In some examples, the primary container port 920 can be sized and shaped to receive the food container 856. In such examples, the food container 856 received by the lid interior volume 878 can be disposed in the primary container port 920 and can be seated on the primary port surface 936. Furthermore, the food container 856 can contact the protrusions 940 to aid securement of the food container 856 relative to the primary container port 920.

In some examples, the secondary container ports 924 can extend from the primary port surface 936 toward the top lid wall 904 to respective secondary port surfaces 944. In such examples, the secondary port surfaces 944 can be recessed relative to the primary port surface 936. As illustrated in FIG. 34, the secondary container ports 924 can define a circular perimeter shape. In such examples, the secondary container ports 924 can be sized and shaped to receive food and fluid and food containers having circular bases, such as bowls, cups, bottles, and other dishware having circular bases. However, in other examples, the secondary container ports 924 can define a perimeter shape having other applicable shapes (e.g., square, rectangular, circular, triangular, hexagonal, or other applicable shapes). Additionally, in some examples, the lid interior volume 878 can include more ports (e.g., tertiary or quaternary ports) configured to receive and retain food or fluid containers having other shapes and sizes.

In some examples, the lid interior volume 878 can be configured to retain and secure an electronic device (e.g., a cell phone, tablet, or other device). For example, a perimeter wall of the lid interior volume 878 extending from the lid base wall 928 to the lid interior volume surface 932 can be sloped (e.g., obliquely angled relative to the lid base wall 928). The angle of the perimeter wall of the lid interior volume 878 can provide a resting location for an electronic device that advantageously tilts a screen of the electronic device toward the user to optimize a viewing angle of the screen. Furthermore, in some examples, the electronic device can rest against the protrusions 940 that define the primary container port 920. The protrusions 940 can act as a contact against which an edge of the electronic device can be rested to help secure the electronic device (e.g., against slipping) relative to the perimeter wall of the lid interior volume 878.

Referring now to FIG. 35, as described above, the food container lid 870 can be secured to the food container 856 using food container fasteners 864. In some examples, the food container fasteners 864 can be advantageously shaped to provide enhanced finger access to the food container fasteners 864 to ease the coupling and decoupling of the food container fasteners 864 relative to the container lip 874. As illustrated in FIG. 35, the container fasteners 864 can include clamps 948, defining a hooked end 952 that can engage the container lip 874. Specifically, the container fasteners 864 extend from a clamp hinge 956, that couples the container fasteners 864 to the container lid 870, to the hooked ends 952 that can engage the container lip 874.

In some examples, each of the container fasteners 864 can include clamp handles 960. The clamp handles 960 can provide a grip for the user to manually manipulate the container fasteners 864 between a coupled position and a decoupled position (e.g., relative to the container lip 874). The clamp handles 960 can extend between the clamps 948 of the respective container fasteners 864. Furthermore, the clamp handles 960 can extend from the clamp hinge 956, along the clamps 948 and toward the hooked ends 952 of the clamps 948. As illustrated in the FIG. 35, the clamp handles 960 may only extend partway (e.g., less than halfway) from the clamp hinge 956 to the hooked ends 952 of the clamps 948. Furthermore, a grip end of the clamp handles 960, opposite the clamp hinge 956, can define a planar section to aid the engagement of a user's fingers.

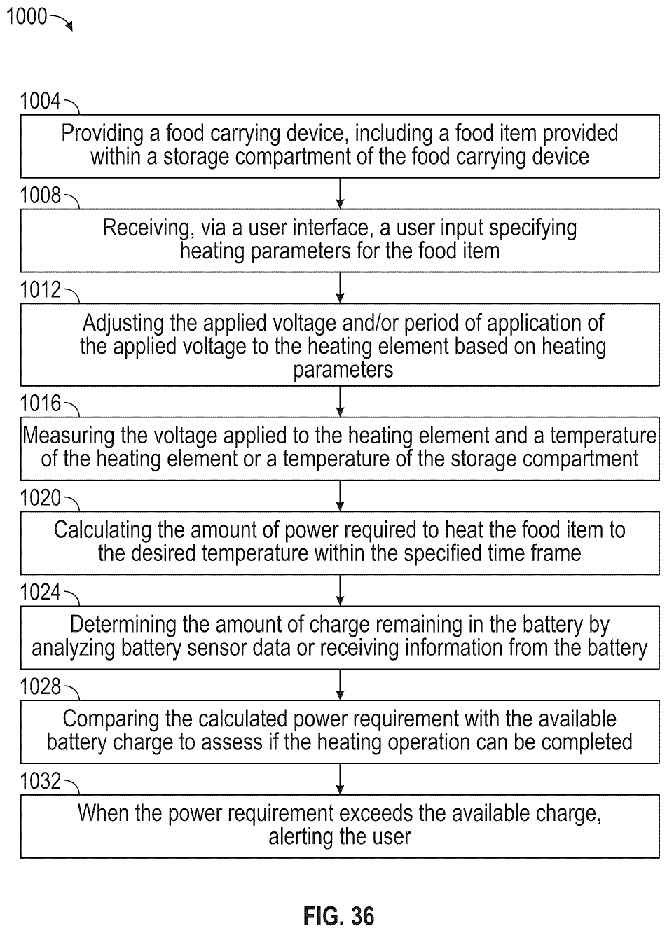

In view of the above description of the food carrying devices 100, 200, 400, FIG. 36 illustrates one embodiment of a method 1000 of alerting the user to a lack of charge in the battery 456. The method 1000 can include step 1004, providing a food carrying device, including a food item provided within a storage compartment of the food carrying device. The method 1000 can include step 1008, receiving, via a user interface, a user input specifying heating parameters for the food item. The heating parameters can include a desired temperature and either a specified amount of time or a specified ready time, or can include a manual “heat on” or desired heating level designation. The method 1000 can further include step 1012, adjusting the applied voltage and/or period of application of the applied voltage to the heating element based on heating parameters. The method 1000 can include step 1016, measuring the voltage applied to the heating element, and a temperature of the heating element or a temperature of the storage compartment. The method 1000 can include step 1020, calculating the amount of power required to heat the food item to the desired temperature within a specified timeframe. In some examples, calculating the amount of power required to heat the food item to the desired temperature within a specified timeframe can include calculating a first amount of energy required to power the heating element until a desired mealtime. For variable heating profiles, calculating a first amount of energy required to power the heating element until a desired mealtime can include calculating the amount of energy required to power the heating element for the entire variable heating profile. In such examples, the heating profile can include at least activating the heating element to output heat at a first heating level for a first period of time, and activating the heating element output heat at a second heating level for a second period of time. The method 1000 can include step 1024, determining the amount of charge remaining in the battery by analyzing battery sensor data or receiving information from the battery. In some examples, determining the amount of charge remaining in the battery can include calculating a second amount of energy stored in the battery. The method 1000 can include step 1028, comparing the calculated power requirement with the available battery charge to assess if the heating operation can be completed. Comparing the calculated power requirement with the available battery charge can include comparing the first amount of energy to the second amount of energy. The method 1000 can include step 1032, when the power requirement exceeds the available charge, alerting the user. In some examples, the power requirement can exceed the available charge, and the user can be alerted, when the first amount of energy is greater than the second amount of energy. In other examples, the power requirement can exceed the available charge, and the user can be alerted, when the amount of energy stored in the battery is less than the amount of energy required to power the heating element for the heating profile. Furthermore, alerting the user can include using one or more of a visual alert and an auditory alert.

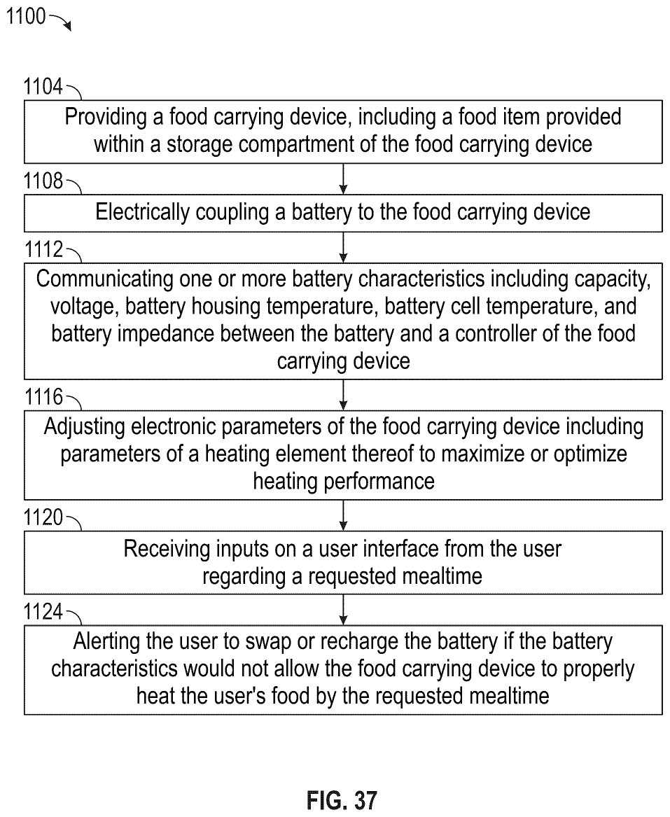

FIG. 37 illustrates one embodiment of a method 1100 of alerting the user to a lack of charge in the battery 456. The method 1100 can include step 1104, providing a food carrying device, including a food item provided within a storage compartment of the food carrying device. The method 1100 can include step 1108, electrically coupling a battery to the food carrying device. The method 1100 can include step 1112, communicating one or more battery characteristics such as, but not limited to, capacity, voltage, battery housing temperature, battery cell temperature, and battery impedance between the battery and a controller of the food carrying device. The method 1100 can include step 1116, adjusting electronic parameters of the food carrying device including parameters related to a heating element thereof to maximize or optimize heating performance. The method 1100 can include step 1120, receiving inputs on a user interface from the user regarding a requested mealtime. The method 1100 can include step 1124, alerting the user to swap or recharge the battery if the battery characteristics would not allow the food carrying device to properly heat the user's food by the requested mealtime. For example, the controller can determine that the battery characteristics would not allow the food carrying device to properly heat the user's food by the requested mealtime by calculating a temperature of the food container or interior compartment and/or a heating period needed to properly heat the user's food, calculating an amount of power required for heating element operation to achieve the temperature and heating period, and determining whether the battery characteristics indicate that the battery can provide the required power.

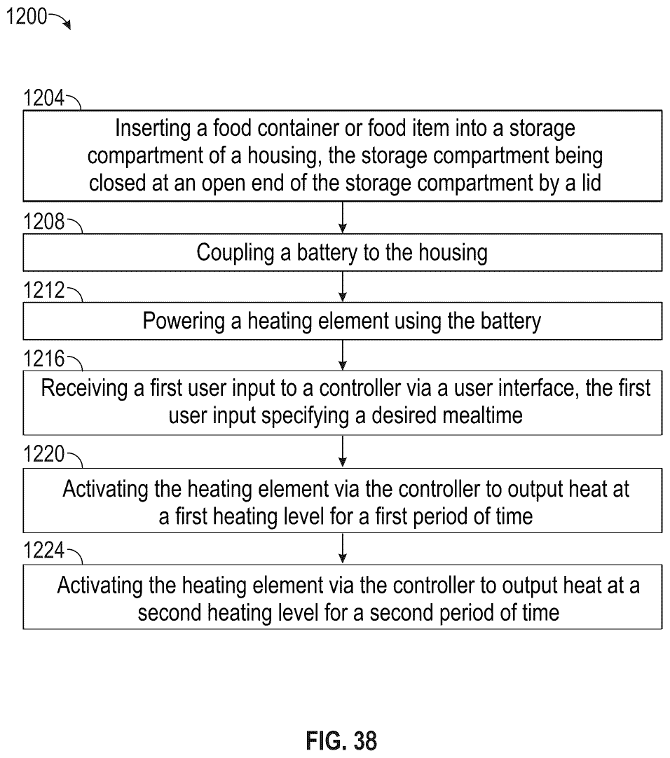

FIG. 38 illustrates one embodiment of a method 1200 of warming a food item using the food carrying devices 100, 400, 700. The method 1200 can include step 1204, inserting a food container or food item into a storage compartment of a housing, the storage compartment being closed at an open end of the storage compartment by a lid. The method 1200 can include step 1208, coupling a battery to the housing. The method 1200 can include step 1212, powering a heating element using the battery. The method 1200 can include step 1216, receiving a first user input to a controller via a user interface, the first user input specifying heating parameters, such as a desired mealtime. The method 1200 can include step 1220, activating the heating element via the controller to output heat at a first heating level for a first period of time. The method 1200 can include step 1224, activating the heating element via the controller to output heat at a second heating level for a second period of time. In some examples, the method 1200 can further include activating the heating element at third or fourth heating levels for third or fourth periods of time.

In some examples, the controller of the method 1200 first activates the heating element to output heat at the first heating level and then activates the heating element to output heat at the second heating level. In such examples, the first heating level can be a lower heating level than the second heating level. However, in other examples, the first heating level can be a higher heating level than the second heating level.

In some examples, the heating element of the method 1200 may output no thermal energy at the first heating level. In such examples, step 1220 may act as a delayed activation function. More specifically, for mealtimes scheduled in the distant future (e.g., three hours or more) the food carrying devices 100, 400, 700 can wait for a period of time (e.g., the first period of time), before the heating element is activated at the second heating level and the food item in the food carrying devices 100, 400, 700 begins to be warmed.

The previous description of the disclosed embodiments is provided to enable any person skilled in the art to make or use the invention. Various modifications to these embodiments will be readily apparent to those skilled in the art, and the generic principles defined herein can be applied to other embodiments without departing from the spirit or scope of the invention. Thus, the invention is not intended to be limited to the embodiments shown herein but is to be accorded the widest scope consistent with the principles and novel features disclosed herein.

In some implementations, devices or systems disclosed herein can be utilized or installed using methods embodying aspects of the invention. Correspondingly, description herein of particular features or capabilities of a device or system is generally intended to inherently include disclosure of a method of using such features for intended purposes and of implementing such capabilities. Similarly, express discussion of any method of using a particular device or system, unless otherwise indicated or limited, is intended to inherently include disclosure, as embodiments of the invention, of the utilized features and implemented capabilities of such device or system.

It is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Also as used herein, unless otherwise specified or limited, directional terms are presented only with regard to the particular embodiment and perspective described. For example, reference to features or directions as “horizontal,” “vertical,” “front,” “rear,” “left,” “right,” and so on are generally made with reference to a particular figure or example and are not necessarily indicative of an absolute orientation or direction. However, relative directional terms for a particular embodiment can generally apply to alternative orientations of that embodiment. For example, “front” and “rear” directions or features (or “right” and “left” directions or features, and so on) can be generally understood to indicate relatively opposite directions or features.

While the structures and components disclosed herein can be embodied in many different forms, several specific embodiments are discussed herein with the understanding that the embodiments described in the present disclosure are to be considered only exemplifications of the principles described herein, and the disclosure is not intended to be limited to the embodiments illustrated. Throughout the disclosure, the terms “about” and “approximately” mean plus or minus 5% of the number that each term precedes, inclusive. Similarly, as used herein with respect to a reference value, the term “substantially equal” (and the like) refers to variations from the reference value of less than ±5% (e.g., ±2%, ±1%, ±0.5%) inclusive.

Unless otherwise limited or defined, “substantially parallel” indicates a direction that is within ±12 degrees of a reference direction (e.g., within ±6 degrees or ±3 degrees), inclusive. Correspondingly, “substantially vertical” indicates a direction that is substantially parallel to the vertical direction, as defined relative to gravity, with a similarly derived meaning for “substantially horizontal” (relative to the horizontal direction). Likewise, unless otherwise limited or defined, “substantially perpendicular” indicates a direction that is within ±12 degrees of perpendicular a reference direction (e.g., within ±6 degrees or ±3 degrees), inclusive. Likewise, unless otherwise limited or defined, “substantially radial” indicates a direction that is within ±12 degrees of radial a reference direction (e.g., within ±6 degrees or ±3 degrees), inclusive. Likewise, unless otherwise limited or defined, “substantially axial” indicates a direction that is within ±12 degrees of axial a reference direction (e.g., within ±6 degrees or ±3 degrees), inclusive.

Also as used herein, unless otherwise limited or defined, “substantially identical” indicates that features or components are manufactured using the same processes according to the same design and the same specifications. In some cases, substantially identical features can be geometrically congruent.

Also as used herein, unless otherwise limited or defined, “integral” and derivatives thereof (e.g., “integrally”) describe elements that are manufactured as a single piece without fasteners, adhesive, or the like to secure separate components together. For example, an element stamped, cast, or otherwise molded as a single-piece component from a single piece of sheet metal or using a single mold, without rivets, screws, or adhesive to hold separately formed pieces together is an integral (and integrally formed) element. In contrast, an element formed from multiple pieces that are separately formed initially then later connected together, is not an integral (or integrally formed) element.

We claim:

1. A food carrying device for warming food, the food carrying device comprising:
a housing including a storage compartment defining a base and a plurality of sidewalls, the storage compartment defining a storage volume for receiving a food container or food item, the storage volume extending between the base of the storage compartment and an open end of the storage compartment opposite the base;
a lid secured to the housing to close the open end of the storage compartment;
a heating element extending along the storage compartment,
a battery configured to power the heating element;
a user interface disposed on an exterior surface of the housing;
a controller connected to the heating element and the user interface, the controller configured to receive inputs from a user via the user interface; and
the controller receiving as a first input a desired mealtime, in response to the first input the controller controls the heating element to:
output heat at a first heating level for a first period of time; and
output heat at a second heating level for a second period of time.

2. The food carrying device of claim 1, wherein the heating element outputs less thermal energy at the first heating level as compared to the second heating level.

3. The food carrying device of claim 2, wherein the heating element outputs no thermal energy at the first heating level, and wherein, in response to the first input, the controller further controls the heating element to output heat at a third heating level for a third period of time.

4. The food carrying device of claim 1, wherein the controller compares an amount of energy stored in the battery to an amount of energy required to power the heating element for the first and second periods of time, and wherein the controller is configured to alert the user if the amount of energy stored in the battery is less than the amount of energy required to power the heating element for the first and second periods of time.

5. The food carrying device of claim 4, wherein the control alerts the user via the user interface using one or more of a visual alert and an auditory alert.

6. The food carrying device of claim 1, wherein the lid is rotatably coupled to the housing, and wherein the lid is selectively decouplable and removable from the housing.

7. The food carrying device of claim 6, wherein the lid includes one or more recesses shaped to hold a base of the food container or a base of a fluid reservoir.

8. The food storage device of claim 1, wherein the housing includes a battery port to receive the battery.

9. The food storage device of claim 1 further comprising a plurality of engaging features, the engaging features being couplable to a portable storage system.

10. The food storage device of claim 1 further comprising a memory, the memory configured to store a plurality of heating profiles, the heating profiles including activation instructions regarding the heating level of the heating element level and period of activation, wherein the controller is configured to select and execute one of the heating profiles based on the input to the user interface.

11. The food carrying device of claim 1, further comprising a handle rotatably coupled to the lid, the handle configured to support the lid against a surface in a horizontal position when the lid is in an open configuration.

12. A food carrying device for warming food, the food carrying device comprising:
a housing including a storage compartment, the storage compartment defining a storage volume for receiving a food container or food item;
a lid secured to the housing;
a heating element to heat the storage compartment,
a battery to power the heating element;
a user interface to receive inputs from a user; and
a controller connected to the heating element and the user interface,
the controller receiving a first input to the user interface corresponding to a heating parameter, in response to the first input the controller calculates a heating profile for the heating element, the heating profile including:
a first activation level of the heating element and a first period of activation of the heating element; and
a second activation level of the heating element and a second period of activation of the heating element.

13. The food carrying device of claim 12, wherein the controller compares an amount of energy stored in the battery to an amount of energy required to power the heating element for the heating profile, and wherein the controller is configured to alert the user if the amount of energy stored in the battery is less than the amount of energy required to power the heating element for the heating profile.

14. The food carrying device of claim 12, wherein the lid is coupled to the housing via a hinge, the hinge including a first hinge portion extending from the housing that is coupled to a second hinge portion extending from the lid, the first hinge portion being selectively decouplable from the second hinge portion to remove the lid from the housing.

15. The food carrying device of claim 14, wherein the lid includes one or more recesses shaped to hold a base of the food container or a base of a fluid reservoir.

16. The food carrying device of claim 12, further comprising a heat sensor in communication with the controller and configured to generate a temperature signal, wherein the controller adjusts the heating profile based on the temperature signal.

17. The food carrying device of claim 12, wherein activating the heating element at the first activation level causes the heating element to output less thermal energy as compared to activating the heating element at the second activation level.

18. A method for using a food carrying device, the food carrying device comprising a storage compartment to receive a food container or food item, the method comprising:
coupling a battery to a housing of the food carrying device;
powering a heating element using the battery;
receiving a first user input to a controller via a user interface, the first user input specifying a desired mealtime; and
based on the desired mealtime,
activating the heating element via the controller to output heat at a first heating level for a first period of time, and
activating the heating element via the controller to output heat at a second heating level for a second period of time.

19. The method of claim 18 further comprising:
calculating a first amount of energy required to power the heating element until the desired mealtime;
calculating a second amount of energy stored in the battery;
comparing the first amount of energy to the second amount of energy; and
alerting a user if the first amount of energy is greater than the second amount of energy.

20. The method of claim 18, wherein the controller first activates the heating element to output heat at the first heating level, and then activates the heating element to output heat at the second heating level, and wherein the first heating level is a lower heating level than the second heating level.
